(19) United States
(12) Patent Application Publication
(10) Pub. No.: US 2007/0299880 A1
(43) Pub. Date: Dec. 27, 2007

(54) Document Management Server, Document Management Method, Computer Readable Medium, Computer Data Signal, and System For Managing Document Use

(75) Inventors: Shigehisa Kawabe, Kanagawa (JP); Setsu Kunitake, Kanagawa (JP); Taro Terao, Kanagawa (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 11/559,017

(22) Filed: Nov. 13, 2006

(30) Foreign Application Priority Data
Jun. 22, 2006 (JP) 2006-172737

(51) Int. Cl. G06F 17/30

(52) U.S. Cl. 707/200

(57) ABSTRACT

There is provided a document management server including a receiving unit that receives from a client a request and a first ID representing a document, an ID processing unit that issues, when an operation is performed on the document, a second ID, and records a derivation relationship having the second ID as a child of the first ID, a base node setting unit that sets a base node to indicate a division of a user among a node group in the derivation relationship, a document associating unit that associates related data of the document registered by an operation corresponding to a descendent node of a base node to the base node, and a document provider unit that provides, when receiving a user request for a digital document, detects a base node by tracing the derivation relationship from an ID accompanying the request to the root node, and provides the requested document based on related data associated to the detected base node.

### PRIORITY INFORMATION

This application claims priority from Japanese Patent Application No. 2006-172737, filed on Jun. 22, 2006.

### BACKGROUND

1. Technical Field

The present invention relates to a system for managing the use of digital documents.

2. Related Art

Heretofore, digital documents (referred to hereinafter as simply documents), such as document data and audio data, image data, multimedia data, and programs, were registered into a document management server and these documents were provided in response to user requests. In this type of system for managing the use of digital documents, added value was provided by the document management functions of the server, such as document attribute management, access management, version management, management of appended information (for example, document attachments), and so forth. However, these types of value-added information are managed by the server so that a document after having been extracted from the server and in the process of being distributed is not generally appended with such value-added information. Mapping between a document in an open environment being distributed in this manner and a document attribute on the server and other value-added information has generally been performed manually in the past, such as by document name.

Furthermore, in a known system or apparatus of another related art, a digital document is printed by a printer, the identification information or coordinate information listed on the printed result is associated with the digital document and stored in a document management database. Writing is performed on the printed document using a coordinate input device or electronic information input interface, such as an electronic pen, and the obtained update information of the digital document based on identification information or coordinate information is associated with the digital document and stored and updated in an operation history management database or operation history management document folder.

In one conventional system of this type, manual-based editing on a paper document is directly reflected in a digital document and a series of updated versions of digital documents is stored as a tree configuration with the digital documents as nodes.

### SUMMARY

According to an aspect of the invention, there is provided a document management server for managing digital documents to be provided to clients including a receiving unit that receives from a client a request and a first ID representing a digital document to be an object of the request, an ID processing unit that issues, when an operation is performed on the digital document in response to the request, a second ID that is associated to the operation, and records a derivation relationship having the second ID as a child of the first ID, a base node setting unit that sets a base node to indicate a division among a node group in the derivation relationship tree, a document associating unit that associates related data of the digital document registered by an operation corresponding to a descendent node of a base node to the base node, and a document provider unit that provides, when receiving a user request for a digital document, detects a base node by tracing the derivation relationship from an ID accompanying the request to the root node, and provides the requested document based on related data associated to the detected base node.

### BRIEF DESCRIPTION OF THE DRAWINGS

Embodiments of the present invention will be described in detail based on the following figures, wherein:

FIG. 1 is a block diagram showing a simplified configuration of a system for managing document use that uses duplicate shortcuts;

FIG. 2 shows an example of an internal configuration of a client terminal;

FIG. 3 shows an example of an internal configuration of a document management server;

FIG. 4 shows one example of log data generated by a log management unit;

FIG. 5 shows a derivation relationship tree of the duplicate IDs shown in the log data of FIG. 4;

FIG. 6 illustrates a system operation in the case where the log data of FIG. 4 is generated;

FIG. 7 shows an overall configuration of a system for managing document distribution within an organization;

FIG. 8 shows one example of user information registered in an organization information management database;

FIG. 9 shows an internal configuration of the document management server in the system of FIG. 7;

FIG. 10 is a flowchart showing a procedure of the document registration unit when a document registration request is received in the overall management method;

FIG. 11 is a flowchart showing a procedure of the duplicate provider unit when a read request is received in the overall management method;

FIG. 12 is a flowchart showing a procedure of the document registration unit when an update request is received in the overall management method;

FIG. 13 shows a derivation relationship tree at a certain point in time in a specific example of document distribution within an organization;

FIG. 14 shows the content of log data corresponding to the derivation relationship tree of FIG. 13;

FIG. 15 shows a derivation relationship tree when a user belonging to office A updates a document after the state of FIG. 13;

FIG. 16 shows the content of log data when the same user reads the document after the update and after the state of FIG. 15;

FIG. 17 shows a derivation relationship tree when another user belonging to office B updates and reads the document;

FIG. 18 shows a derivation relationship tree when another user belonging to office A updates and reads the document;

FIG. 19 corresponds to the derivation relationship tree of FIG. 18;

FIG. 20 shows a derivation relationship tree when a user belonging to office A reads the document;

FIG. 21 shows one example of a derivation relationship tree in the differential management method;

FIG. 22 is a flowchart showing a procedure of the document registration unit when a document registration request is received in the differential management method;

FIG. 23 is a flowchart showing a procedure of the duplicate provider unit when a read request is received in the differential management method;

FIG. 24 is a flowchart showing a procedure of the document registration unit when an update request is received in the differential management method;

FIG. 25 shows a derivation relationship tree in a method for updating a document set by the addition of a document attachment;

FIG. 26 is an example of log data in a method for updating a document set by the addition of a document attachment;

FIG. 27 is a flowchart showing a procedure of the document registration unit when an original document registration request is received in a method for updating a document set by the addition of a document attachment;

FIG. 28 is a flowchart showing a procedure of the duplicate provider unit when a read request is received in a method for updating a document set by the addition of a document attachment;

FIG. 29 is a flowchart showing a procedure of the duplicate registration unit when a document attachment registration request in a method for updating a document set by the addition of a document attachment;

FIG. 30 is a flowchart showing a procedure of the document registration unit when an update request is received in a method for collecting update information of descendents of a base node upon a read request;

FIG. 31 is a flowchart showing a procedure of the duplication unit when a read request is received in a method for collecting update information of descendents of a base node upon a read request;

FIG. 32 is one example of a hardware configuration of a computer equipped with a device of the embodiment.

### DETAILED DESCRIPTION

### Overview of a System for Managing Document Use Using Duplicate Shortcuts

First, a system for managing document use using duplicate shortcuts will be described.

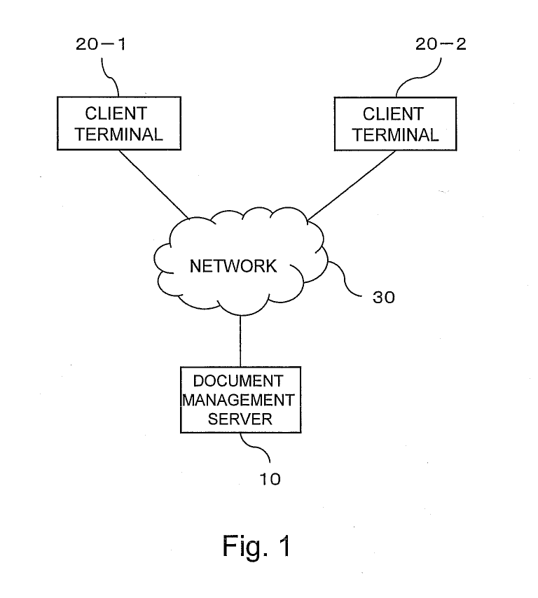

FIG. 1 is a block diagram showing a general configuration of a system for managing document use. This system includes a document management server 10 and client terminals 20-1, 20-2, and so forth (collectively referred to hereinafter as client terminal 20) connected via a network 30, such as the Internet or a local area network.

In this system, the original file of a digital document is managed by the document management server 10 and security of the digital document is ensured by not storing the file of the digital document in the client terminal 20. Instead of the file of the digital document itself, a file called a duplicate shortcut (referred to hereinafter as duplicate SC) that includes information for accessing the digital document is kept in the client terminal 20. The duplicate SC may include identification information for management called a duplicate ID, access information, such as a host name of the document management server 10 or an URL (Uniform Resource Locator) for the document read request, and an attribute for the duplicate SC. One example of information included in a duplicate SC: “id=1234567, host=foo.fujixerox.co.jp, createDate=2005/05/24 11:12:34”

In this example, “id=1234567” represents the duplicate ID, “host=foo.fujixerox.co.jp” represents the host name of the document management server 10, and “createDate=2005/05/24 11:12:34” represents the creation date and time, which is one attribute of the duplicate SC. To prevent data leakage, the duplicate shortcut does not include the actual digital document. However, so that the user can identify the digital document for the duplicate SC, part of the digital document, such as the information from only the first page, or a thumbnail image from each page of the digital document may be included in the duplicate SC as a low-quality sample of the digital document.

The access information that is included in the duplicate SC is used when the client terminal 20, which uses the duplicate SC, accesses the document management server 10 that manages the original corresponding to the duplicate SC. However, if a server is provided on the network (and this server address is included in the duplicate SC or known by a viewer 22) for resolving the access information for the document management server 10 that manages the corresponding original from the duplicate ID, the access information for the document management server 10 need not be included in the duplicate SC.

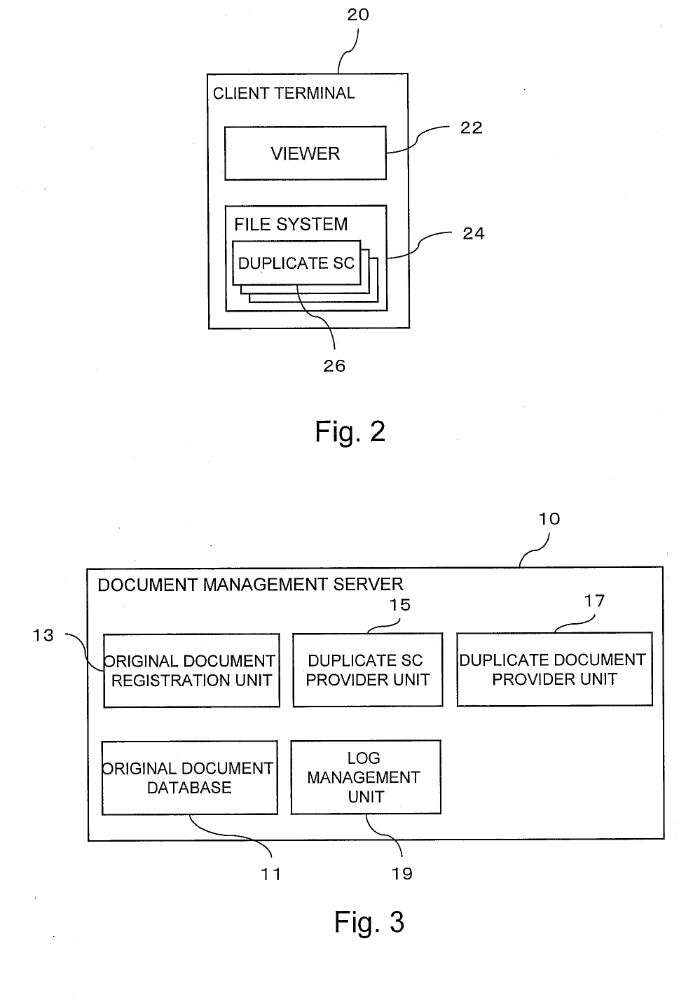

As shown in FIG. 2, other application files are stored together with a file for a duplicate SC 26 in a file system 24 in the client terminal 20. The duplicate SC 26 is created as a file in a format that can hold attribute information with body data of a document, such as PDF (Portable Document Format) developed by Adobe Systems Incorporated or DocuWorks (registered trademark) developed by Fuji Xerox Co., Ltd. In this case, a duplicate ID and access information are included as attribute information in the file for the duplicate SC 26. When a user desires to read or perform another operation with respect to a digital document in the document management server 10, the user selects the duplicate SC 26, similar to an ordinary shortcut file, corresponding to the digital document from a file list screen provided by the file system 24 or search software and performs the operation. Then, the viewer 22, which has been associated with the file format of the duplicate SC 26, starts, the viewer 22 access the document management server 10 using the access information and duplicate ID within the duplicate SC 26, and a duplicate document file, which is a copy of the digital document corresponding to the duplicate ID, is acquired. The viewer 22 displays the duplicate file and editing operations can be performed on the duplicate file according to operations by the user. The duplicate file includes information (such as an updated duplicate ID to be described hereinafter) indicating that the file is a duplicate and from this information the viewer 22 recognizes that the file is a duplicate. The viewer 22 does not store the duplicate file in the file system 243. The duplicate file is only opened in memory space that is managed by the viewer 22 in the client terminal 20 and is not stored in the file system 24. Acrobat (registered trademark) of Adobe Systems Incorporated, which is compatible with the PDF format, may be used as the viewer 22. The functions (some of which have already been described and will be further described hereinafter) handled in the duplicate SC that are inherent in this system may be added to an existing viewer, such as Acrobat, in the form of plug-ins.

In this system, every time a user performs an operation with respect to an original digital document on the document management server 10 by using a duplicate SC on the client terminal 20, the document management server 10 issues a duplicate ID for updating and updates the duplicate ID within the duplicate SC on the client terminal 20 with the new duplicate ID. In this manner, every time an operation is performed on a digital document using a duplicate SC in this system, the duplicate ID within the duplicate SC is renewed. For example, if a user X requests a duplicate file of a digital document from the document management server 10 by using a duplicate SC and then acquires and reads the duplicate file, the value of the duplicate ID within the duplicate SC located in the client terminal 20 of the user X changes before and after the read operation. Therefore, if an instance is considered where the user X attaches a copy of the duplicate SC to an e-mail and sends the e-mail to another user Y, the duplicate ID in the duplicate SC that the user Y receives will differ depending on whether it was sent before or after the read operation. If a user requests an operation on a digital document using a duplicate SC, the duplicate ID included in the duplicate SC is sent from the client terminal 20 to the document management server 10 so that the document management server 10 can recognize from the received duplicate ID that the duplicate SC, which was the basis of the request, corresponds to a step of a certain operation (such as before or after reading by the user X). Furthermore, if the duplicate ID is associated with identification information for the original digital document (referred to as the document ID) and the user ID of the user (or user ID where the duplicate ID was issued) who performed the operation causing the issuance of the duplicate ID, and stored at the document management server 10, the user operation and the document subjected to the operation can be determined from the duplicate ID so that the distribution of digital documents can be tracked in detail.

The duplicate ID represents unique identification information within the system and corresponds to each operation that a user performs with respect to a digital document. The duplicate ID may be a serial number that is incremented with each operation. However, from the viewpoint of hindering attacks based on guessing by third parties, a value generated by using a generation rule that ensures high uniqueness and is difficult to guess may be used, such as a sufficiently long random number. Furthermore, a hash value (having a sufficiently large number of digits) of attribute information that changes with the issuance of each duplicate ID, such as the generated date and time of the duplicate ID, or a hash value of a combination of fixed attribute information, such as the identification information of an original corresponding to the duplicate ID, with changing attribute information, can also be used for the duplicate ID.

As shown in FIG. 3, the document management server 10 includes an original document database 11, an original document registration unit 13, a duplicate SC provider unit 15, a duplicate document provider unit 17, and a log management unit 19.

The original document database 11 stores and manages digital documents as originals that have been uploaded from the client terminal 20. Within the framework of this system, only a digital document stored in the original document database 11 is handled as an original. Within this framework, even if a copy of the digital document exists on the network, it can be handled as being unrelated to the original. In particular, if the viewer 22 in the client terminal 20 does not store a duplicate document file in the file system as described hereinabove, the possibility of copies of the original being circulated on the network can be greatly reduced.

The original document registration unit 13 registers the digital document, which has been uploaded from the client terminal 20 and is to be registered as an original, into the original document database 11. At this time, the original document registration unit 13 assigns unique identification information referred to as a “document ID” to the original digital document file to be registered. The document ID may be a random number or a hash value.

In response to an operation request from a user, the duplicate SC provider unit 15 issues a duplicate SC for a digital document within the original document database 11 to the user. In response to an operation request from the user, the duplicate document provider unit 17 creates and provides to the user a duplicate file of the requested digital document.

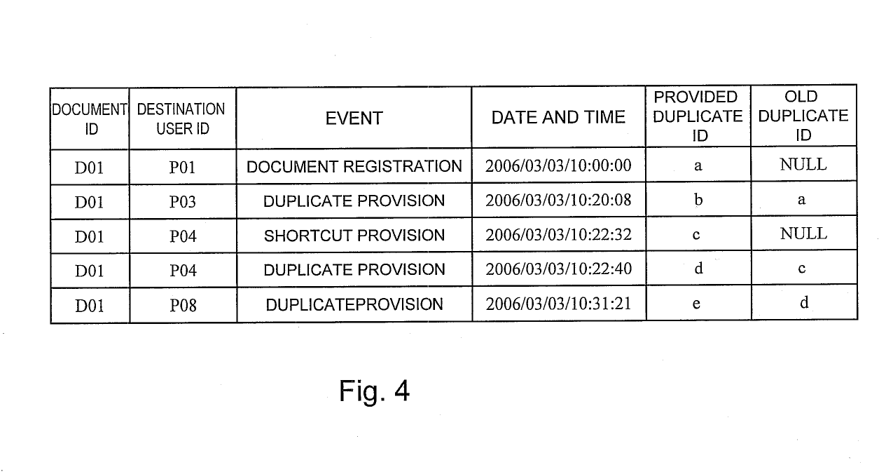

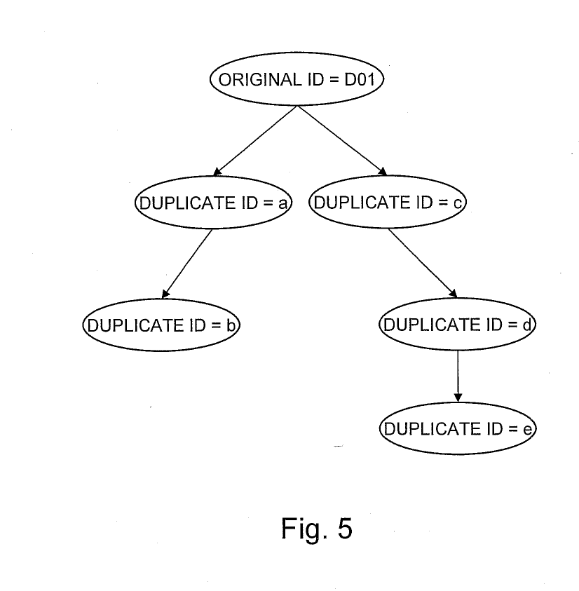

If the document management server 10 executes a process in response to an operation request from the user via the client terminal 20, the log management unit 19 records information relating to the operation as an event log. As shown in FIG. 4, the log management unit 19 records each operational event as a log record the document ID of the original digital document that is the target of the operation, the user ID (destination user ID) of the user (in this case, identical to the user who accessed the document management server 10 for the operation) who is provided with the duplicate ID in the operational event, the type of event, the date and time when the event occurred, the duplicate ID that is provided to the destination user in the event, and the duplicate ID (referred to as old duplicate ID) that is included in the request causing the event. According to this log record, the duplicate ID and the corresponding original document ID are associated. Furthermore, by examining the log record with respect to the duplicate ID, a new duplicate ID provided by the document management server 10 may be associated with respect to the access using the old duplicate ID for the document operation so that the change in the document ID due to an operation may be determined. This change in the duplicate ID may be represented as a relationship where the new duplicate ID is derived from the old duplicate ID due to an operation. Since the same duplicate ID is not derived from multiple different old duplicate IDs due to the uniqueness of the duplicate ID, the derivation relationship assumes a tree form. The derivation relationship of the duplicate IDs in the log data illustrated in FIG. 4 is shown in FIG. 5.

The document management server 10 may be organized using a web server and a web application. In this case, the document management server 10 provides a web page as a user interface screen to the client terminal 20.

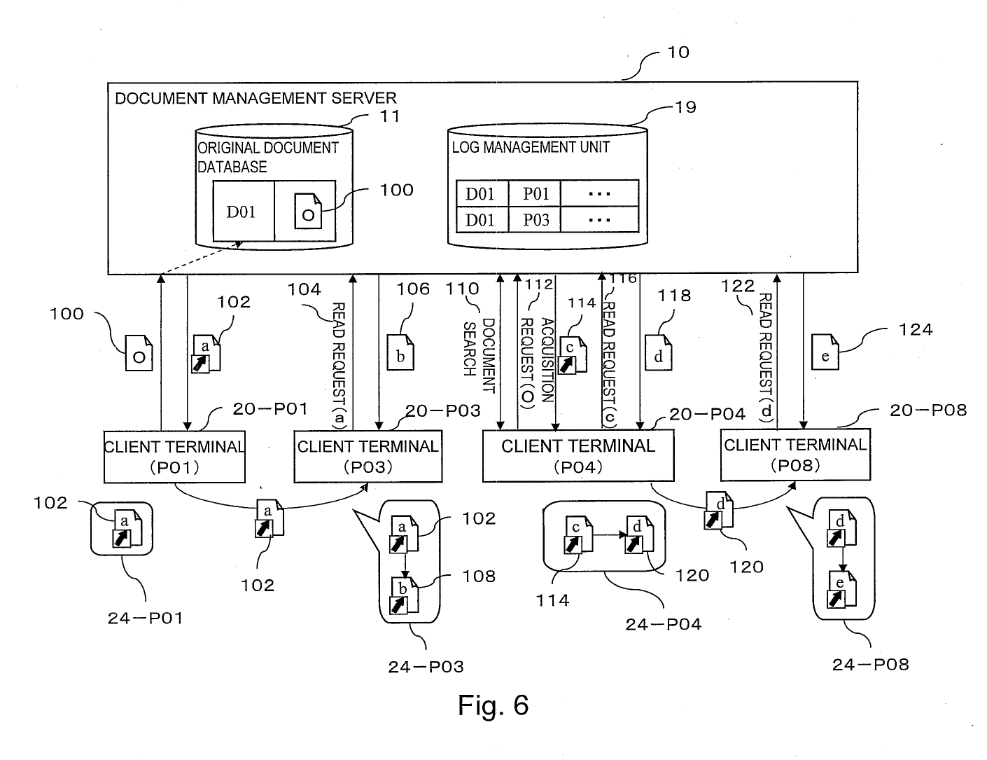

Next, to clarify the mechanism of the system for managing document use, an operation of the system will be described with reference to FIG. 6 when the log data illustrated in FIG. 4 is formed.

First, a user P01 issues a registration request of digital document “O” 100 to the document management server 10 from a client terminal 20-P01. The digital document 100 may be within the local file system of the client terminal 20-P01 or in a file server or a document server on the network. This registration request may be performed via a user interface provided by the viewer 22. The user interface provides a directory screen showing a tree directory of a network file system or a file system, and the selection of a document to be registered is received on this directory screen from the user P01. Furthermore, the user interface may provide a search screen through which a user enters search conditions. The digital documents matching these conditions are searched from a local file system or a network file server and the search results are presented to the user from which the user may select a document to be registered. A registration request issued by the client terminal 20 includes a user ID that identifies the user P01 and the digital document 100 (body data of the document 100 or link information for the body data) to be the target. The user ID that is presented by the user P01 when logging in to the system or the client terminal 20-P01 may be used for the user ID included in the registration request.

At the document management server 10 that receives the registration request, the original document registration unit 13 acquires the body data of the digital document 100 included in the request (or acquires the body data using a link if the link to the body data is included in the request) and attaches a unique document ID “D01” to the digital document. Then, the body data of the digital document 100 is associated with the document ID “D01” and registered into the original document database 11. If the digital document 100 that is sent from the client terminal 20 is not in a document format of the system (such as PDF, for example), the document management server 10 may register the digital document 100 into the original document database 11 after converting into the document format of the system.

Next, the duplicate SC provider unit 15 generates a unique duplicate ID “a”, generates a duplicate SC 102 that includes the duplicate ID “a” and the host name of the document management server 10, and transmits the duplicate SC 102 to the client terminal 20-P01, such as in a response to the registration request. Furthermore, at the document management server 10, the log management unit 19 records the second line of the table shown in FIG. 4 as a log record relating to the aforementioned registration event. In this record, the document ID of the original digital document that is the target of the operational event is “D01” and the user ID of the user who is the destination of the new duplicate ID that is generated in the operational event is “P01”. Furthermore, the type of operational event is “document registration” and the date and time of the event is “2006/03/03/10:00:00”. Moreover, the duplicate ID provided to the destination user as the event result is “a” and the old duplicate ID is not included in the request of this operation in this case and is shown as NULL.

The client terminal 20-P01, which receives the duplicate SC 102 together with the response for registration success, registers the duplicate SC 102 into a file system 24-P01. At this time, the original digital document 100 within the file system 24-P01 may be deleted and a file for the duplicate SC 102 may be stored instead. If this is performed, the original body data of the digital document 100 is stored only in the document management server 10 so it becomes easy to ensure that it is the actual original.

If the user issues a request to the document management server 10 for the registration of the digital document 100 located in a file server on the network, the document management server 10 may send the duplicate SC 102 to the file server. The file server that stores the digital document 100 and receives this request may delete the digital document 100 and instead store the duplicate SC 102. In this case, the user P01 can view the duplicate SC 102 located on the file server on a directory screen of the network file system or the like.

It is assumed here that the user P01 transmits the duplicate SC 102 for the digital document “O” 100 to a user P03, such as by an attachment to an e-mail. Then, the duplicate SC 102 is stored, as a shortcut to the digital document “O”, into a file system 24-P03 of a client terminal 20-P03 of the user P03. To read the digital document “O”, the user P03 opens the duplicate SC 102 at the viewer 22 and enters a read command. The viewer 22 obtains the duplicate ID “a” and the host name of the document management server 10 from the duplicate SC 102, accesses the document management server 10 using the host name, and transmits a read request 104 accompanying the duplicate ID “a”. This read request 104 includes the user ID of the user P03. In subsequent steps also, when the user transmits a request or other data to the document management server 10, the document management server 10 can determine which user is accessing since either the ID of the user is included in the request or the user has logged into the document management server 10 prior to the transmission.

At the document management server 10 that received the read request 104, the duplicate document provider unit 17 starts. The duplicate document provider unit 17 obtains a record having the document ID “a” accompanying the read request 104 as the “provided duplicate ID”, for example, from the log management unit 19, obtains the body data of the digital document “O” indicated by the document ID “D01” in the record from the original document database 11, and creates a copy of the document. Then, the duplicate document provider unit 17 creates a duplicate ID “b” for updating and sets it in the duplicate ID attribute of the file of the copy to create a duplicate file 106. The duplicate file 106 includes the copy of the original document and the duplicate ID “b”. The duplicate file 106 is returned to the client terminal 20-P03 as a response to the read request 104.

Furthermore, the log management unit 19 creates and records a log record, such as the third line in the table of FIG. 4. The read request 104 includes the duplicate ID “a” and the provided duplicate file 106 accordingly includes the duplicate ID “b” so that in this log record the “old duplicate ID” is “a” and the “provided duplicate ID” is “b”. Moreover, in the log record, “D01” is recorded as the target document ID, “P03” is recorded as the destination user ID, and “duplicate provided” is recorded as the event information.

The viewer 22 of the client terminal 20-P03 opens and displays the body data of the document in the received duplicate file 106. Since the duplicate file 106 is attached with a attribute indicating “save disabled”, the viewer 22 does not save the duplicate file 106 into the file system 24-P03. For example, a user interface screen in which a selection to save the duplicate file 106 is not available is provided on the viewer 22. Furthermore, the viewer 22 rewrites the duplicate ID “a” in the duplicate SC 102 stored in the file system 24-P03 to the updated duplicate ID “b” which is included in the duplicate file 106 so that the shortcut to the digital document “O” is renewed. As a result, the duplicate SC 102 in the file system 24-P03 is rewritten into a duplicate SC 108 that includes the duplicate ID “b”.

When considering a case where the user P03 sends the duplicate SC for the digital document “O” to another user, the duplicate SC 102 including the duplicate ID “a” is sent if the sending is prior to the reading of the duplicate file 106 by the user P03. However, if the sending is after the reading of the duplicate by the user P03, the duplicate SC 108 including the duplicate ID “b” is sent.

Next, a case will be considered where a user P04 acquires a digital document, which is managed by the document management server 10. In this case, the user P04 issues a request to the document management server 10 from a client terminal 20-P04 for a directory screen or search screen. A directory screen or search screen for selecting a digital document that is registered within the original document database 11 is generated by the document management server 10 and returned to the client terminal 20-P04. The user P04 finds the desired digital document “O” via the screens. When the user issues a command to acquire the digital document, the client terminal 20 sends an acquisition request 112 accompanying the identification information (such as document ID “D01”) of the digital document “O” to the document management server 10. This is received at the document management server 10 where the duplicate SC provider unit 15 generates a new duplicate ID “c”, generates a duplicate SC 114 including the new duplicate ID “c”, and returns the duplicate SC 114 to the client terminal 20-P04. Then, the log management unit 19 creates a record (fourth line in the table shown in FIG. 4) regarding this event of providing the shortcut.

The client terminal 20-P04 stores the received duplicate SC 114 into a file system 24-P04. When a user selects the duplicate SC 114 and issues a read command, the viewer 22 issues a read request 116 accompanying the duplicate ID “c”. In response, the document management server 10 creates a copy of the original corresponding to the duplicate ID “c”, creates a duplicate ID “d” for updating and sets it to the file attribute of the copy, and creates a duplicate file 118 including the copy and the duplicate ID “d”, and returns it to the client terminal 20-P04. Furthermore, the log management unit 19 records a record, such as the fifth line in the table shown in FIG. 4.

The viewer 22 of the client terminal 20-P04 opens and displays the duplicate file 118 and changes the duplicate ID of the duplicate SC 114 within the file system 24-P04 to the duplicate ID “d” for updating which is included in the duplicate file 118. As a result, the shortcut corresponding to the digital document “O” held by the client terminal 20-P04 becomes a duplicate SC 120.

After the user P04 reads the duplicate of the digital document “O”, the duplicate SC 120 is transmitted to a user P08. When the user P08 uses the duplicate SC 120 to issue a read request 122, the document management server 10 provides a duplicate file 124 including a duplicate ID “e” for updating to the client terminal 20-P08 and records a log record shown as the sixth line in the table of FIG. 4. The viewer 22 of the client terminal 20-P08 opens and provides the received duplicate file 124 to the user and changes the duplicate ID of the duplicate SC within the file system 24-P08 to the duplicate ID “e”.

The destination user ID for the duplicate ID in the operational event was recorded in the log data illustrated in FIG. 4. Additionally, however, the user ID that issued the request causing the event may also be recorded. In the aforementioned example, the user who issued the request causing the event and the destination of the duplicate ID that was newly generated in the event were identical. However, if they are different, it is preferable to record both user IDs as described hereinabove.

The configuration and processing of the system for managing document use to be the basis for the embodiment were detailed hereinabove. A summary of the features of this system:

An original of the digital document is registered in the document management server.

A duplicate SC is provided to the user instead of body data of the digital document. The duplicate SC includes a duplicate ID. When an operation relating to the original is performed on the document management server 10 using the duplicate SC, it is necessary to identify the document management server 10 that manages the original. Thus, the duplicate SC may include information for identifying the document management server 10 that manages the corresponding original.

The document management server manages a correspondence relationship between the duplicate ID of the provided duplicate SC and the corresponding original. (In the aforementioned example, the correspondence relationship between the duplicate ID and the original was managed in a form by being included in the log record of the log management unit 19. The correspondence relationship data may have any form provided the correspondence between both is clear.)

When performing an operation with respect to a document on the document management server, the duplicate ID of the duplicate SC held by the terminal performing the operation is sent to the server.

The document management server identifies the original corresponding to the duplicate ID received from the terminal on the basis of the correspondence relationship between the duplicate ID and the original and performs the requested operation relating to the original.

When an operation relating to the original is performed, the document management server creates a new duplicate ID and sends this duplicate ID to the client terminal that requested the operation. The client terminal that receives this updates the duplicate ID of the duplicate SC used in the request to the received new duplicate ID.

The document management server manages the duplicate ID derivation relationship, which is a correspondence relationship between the duplicate ID that is included in the request from the client terminal and the new duplicate ID that is generated by performing an operation relating to the request.

When a request for an operation which requires body data of the digital document, such as reading of the digital document, is issued from the client terminal, the document management server provides duplicate document data which is a copy of the original to the terminal. The duplicate document data exists only in a region of memory managed by the viewer that operates on the client terminal and is set so that it cannot be stored on disks.

In the aforementioned example, the log record illustrated in FIG. 4 was recorded by the document management server 10. However, this is only one example. For example, in addition or in replacement of the destination user ID, the user name of the destination user may be recorded. The user name may be obtained from the client terminal 20. Furthermore, the name of the organization to which the destination user belongs to may be recorded. The name of the organization to which the user belongs to may be the name of the business or department and may be obtained from an organization information management database that is connected to the present system. The organization information management database is a type of directory server for managing the name of each member of the organization, department, position, contact information, and so forth. In a business system, having this sort of organization information management database is common so that the information can be acquired from the database. Furthermore, for the user name and the organization name, the distinguished name (DN) of the ITU-T recommendation X.509 certification standard may be used. The DN may be acquired from an LDAP (Lightweight Directory Access Protocol) server. Furthermore, the IP (Internet Protocol) address or the MAC (Media Access Control) address of the client terminal 20 that is used by the destination user my be recorded into the log record. The IP address or MAC address can be obtained during access from the client terminal 20.

Furthermore, such operations as document registration, acquisition of the duplicate SC, and document reading were illustrated in the aforementioned example of the system for managing document use. However, besides these operations, all system operations among those relating to the original document can be applied to the aforementioned characteristic processing.

In the systems shown hereinabove and hereinafter, the user ID or other information to be sent to the document management server 10 from the client terminal 20 upon a read request or other request may be placed in an HTTP request header and transmitted, for example, or may be included in an HTTP request written in XML and transmitted. When transmitting a document from the client terminal 20 to the document management server 10, the transmitted information may be a part of the metadata of the document.

Hereinafter, a system for managing document distribution within a hierarchical organization will be described using the framework of the duplicate SC. In the system described hereinabove, documents were only read. However, in the system hereinafter, consideration is also given to instances where updates are added to documents and/or additional data, such as document attachment, is appended to documents.

In this system, a user can set a base node in a node (duplicate ID) of a derivation relationship tree for a digital document and associate and store to the base node a digital document or related data to be shared within a division. Then, the members of the division read digital documents, which have been associated to and stored to the base node, and related data. And any update or data for addition to the digital documents performed by division members is associated to the base node and stored. In this manner, each member belonging to the division can access the digital documents for sharing in their division and the data for updates or additions to the digital documents.

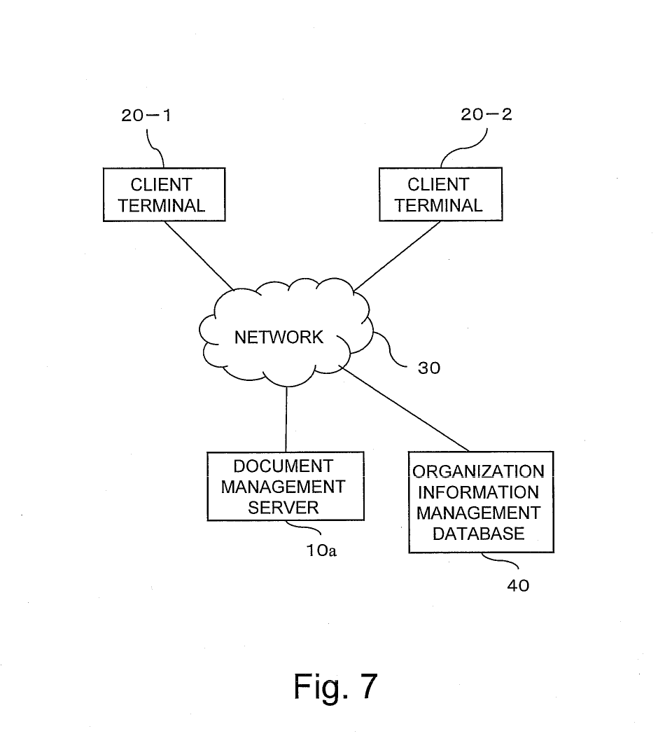

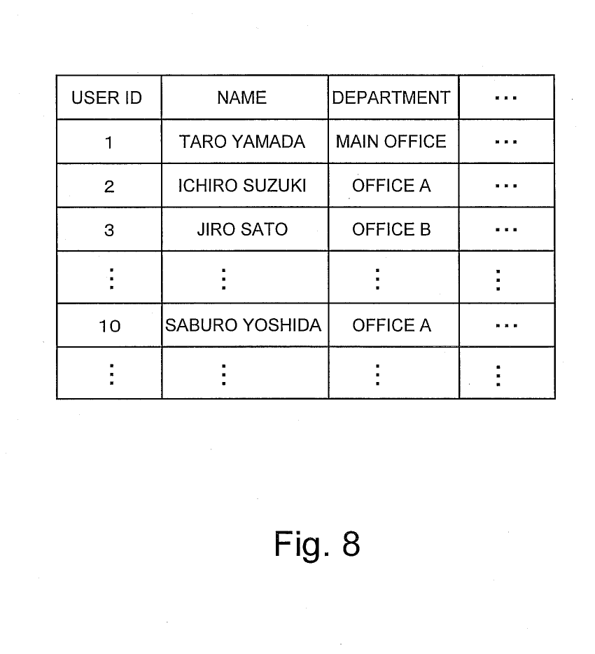

An overall configuration of a system for implementing this type of control is shown in FIG. 7. Compared to the system shown in FIG. 1, the system of FIG. 7 has the addition of an organization information management database 40. The organization information management database 40 stores information on each member of the organization as described hereinabove and information on the division hierarchy in the organization. For example, as shown in FIG. 8, the information registered in the organization information management database 40 for each member includes a unique user ID, user name, and division name. A document management server 10a and the client terminal 20 acquire information on each user from the organization information management database 40 as necessary.

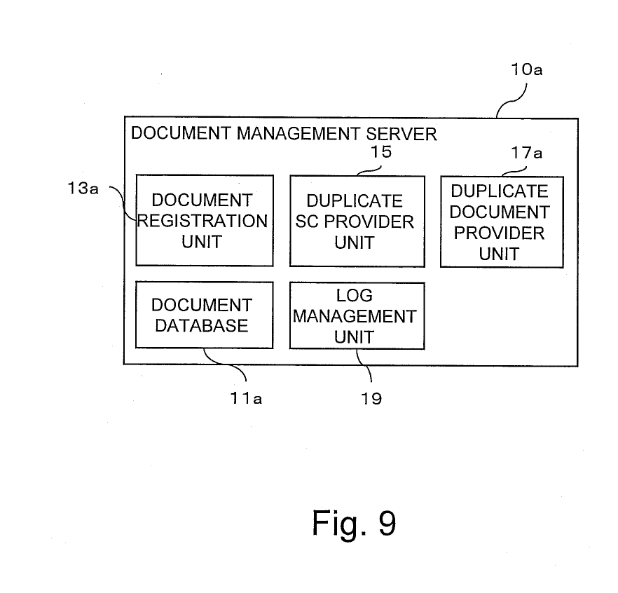

The internal configuration of the document management server 10a in the system of FIG. 7 is shown in FIG. 9. In the document management server 1a shown in FIG. 9, a document database 11a stores not only a digital document (original) to be the root of the derivation relationship tree (refer to FIG. 4) but also data for updates and additions for the original. A document registration unit 13a performs a process for registering data for an update or addition to the original into the document database 11a in response to a registration request for the data. Furthermore, the process of a duplicate document provider unit 17a differs from that of the duplicate provider unit 17 in the example of FIG. 3 when a read request is received. The other components may be identical to those shown in FIG. 3.

Changes added to a document can be generally divided into “updates” that change the content of the document body or “additions” that add document attachments or other data to the document body. An example will first be described for the case for “updates”.

Methods for managing updates of the document body include holding the complete data of the document after each update (hereinafter referred to as “overall management method”) and holding only the difference after the update (hereinafter referred to as “differential management method”). In the differential management method, the differences in the order the updates were performed for the original document are updated to yield the newest document. The overall management method will be described hereinafter as a typical example.

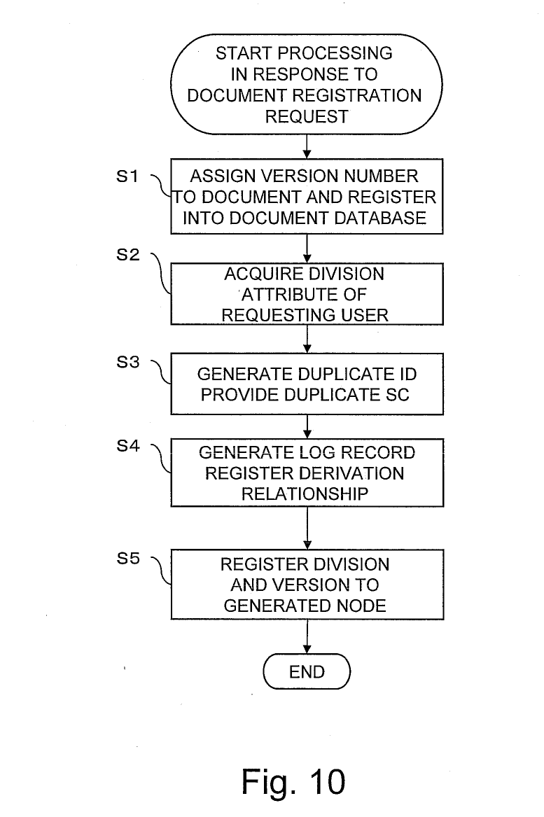

In the overall management method, the document registration unit 13a executes the process shown in FIG. 10 when a document registration request for registering an original document is received from a user.

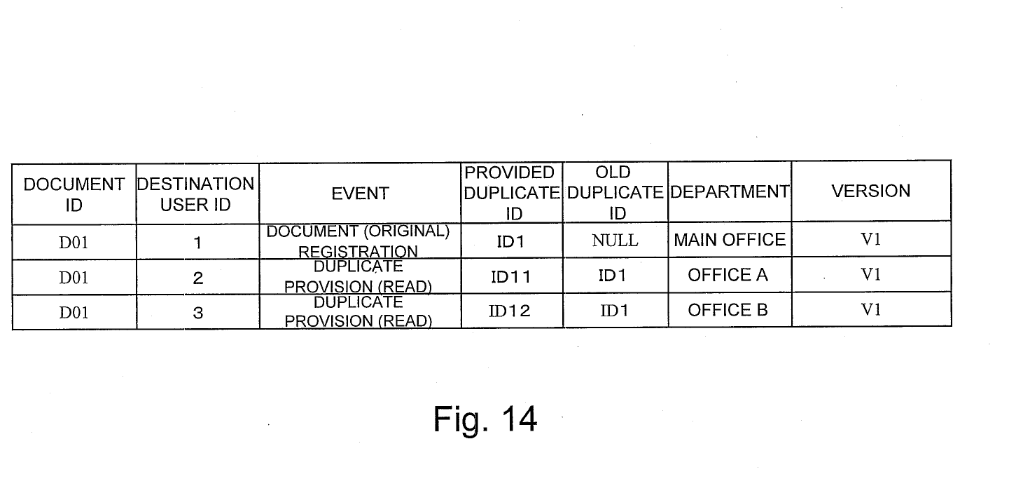

The document registration unit 13a assigns a unique document ID to the document received from the user accompanying the document registration request, assigns a predetermined version number indicating that the document is the original, and associates the document with the document ID and the version number and registers (S1) the document into the document database 11a. Furthermore, the document registration unit 13a acquires (S2) a division attribute of the requesting user. The division attribute of the user may be transmitted by the user to the document management server 10a accompanying the document registration request or may be acquired by the document management server 10a from the organization information management database 40 by using the user information that was received accompanying the document registration request. Furthermore, the document registration unit 13a generates a unique duplicate ID, generates a duplicate SC that includes this duplicate ID, and transmits the duplicate SC to the requesting user (S3). Then, a log record is created and derivation relationship information is registered (S4). In addition to the items shown in FIG. 4, a value of the division attribute of the requesting user causing the event (namely, the user indicating the destination ID) and the version number of the document stored in the document database 11a are also registered (S5) into the log record that is created. An example of a log record group created in this manner is shown in FIG. 14. It should be noted that the execution sequence of steps in FIG. 10 is only one example. Steps not mutually dependent may be executed in any sequence.

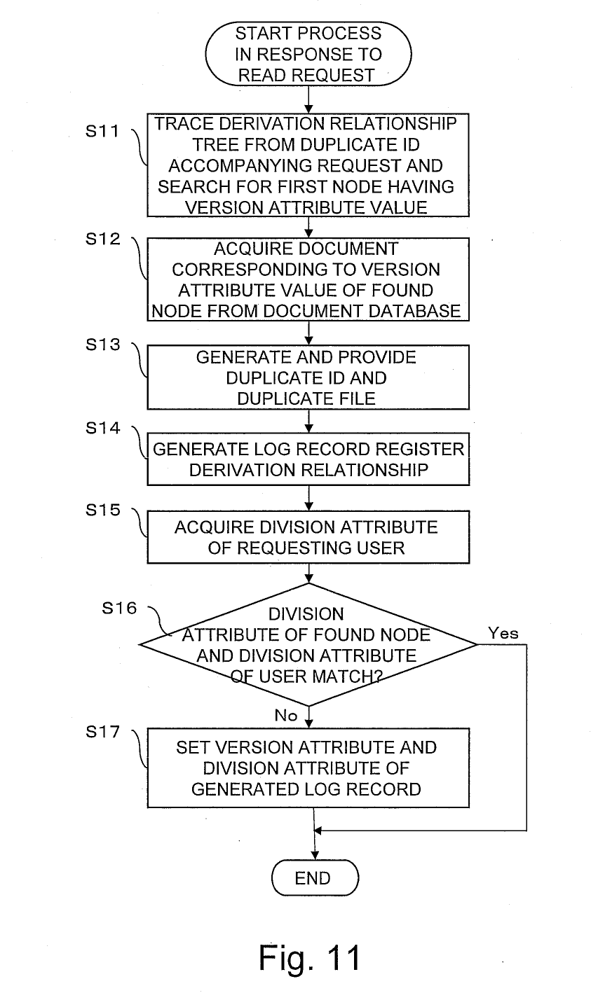

Next, a procedure of the duplicate provider unit 17a will be described with reference to FIG. 11 when a document read request is received from a user in the overall management method.

The read request is performed by using the duplicate SC as described hereinabove. The duplicate ID that includes the duplicate SC is sent accompanying the read request from the client terminal 20 to the document management server 10a. The duplicate provider unit 17a receiving the duplicate ID traces the derivation relationship tree one node at a time (log record) to the root from the duplicate ID, checks whether or not the node has been set with a version attribute value (version number), and repeats the trace (S11) until a node that has been set with a version attribute value is reached. This system records the value of the version number to be shared at the division into the base node of the division in the hierarchy structure of the organization. The value of the version is not recorded at the other nodes besides the base node. Therefore, in step S11, to identify the version that is to be provided to the user who issued the read request, the base node is searched. Then, the document corresponding to the version attribute value (version number) at the node found from the search is acquired (S12) from the document database 11a. Here, if the version number that is assigned by the document management server 10a is unique only in a version group derived from the same document, the document database 11a is searched in step S12 for document data corresponding to a combination of version number and document ID of the original. Then, the duplicate provider unit 17a generates a new duplicate ID, generates a duplicate file that includes this duplicate ID and the document that was acquired in step S12, and provides (S13) the duplicate file to the user who issued the read request. Next, a log record including information on the provided duplicate ID is generated and recorded (S14) into the log management unit 19. Values of the division attribute and version attribute are not recorded into the log record that is generated here.

Furthermore, the duplicate provider unit 17a acquires (S15) the value of the division attribute of the user who issued the read request as in step S1 and judges (Sl6) whether or not the division attribute value found in step S11 matches the division attribute value of the user acquired in step S15. If they match, this signifies the node found in step S11 is the base node of the division to which the user belongs. In this case, nothing further is performed and the process terminates.

On the other hand, if it is judged in step S16 that the division attribute value of the node and the division attribute value of the user do not match, this signifies the node is the base node of a division one level higher than the division to which the user belongs. In this case, the node (i.e. log record) that was generated in respond to the read request is the first node in the division to which the user belongs. Therefore, the duplicate provider unit 17a records (S17) to the node (log record) the value of the division attribute of the user and the version attribute value acquired in step S12. As a result, that node is set as the base node of that division. Then, the duplicate provider unit 17a terminates the process.

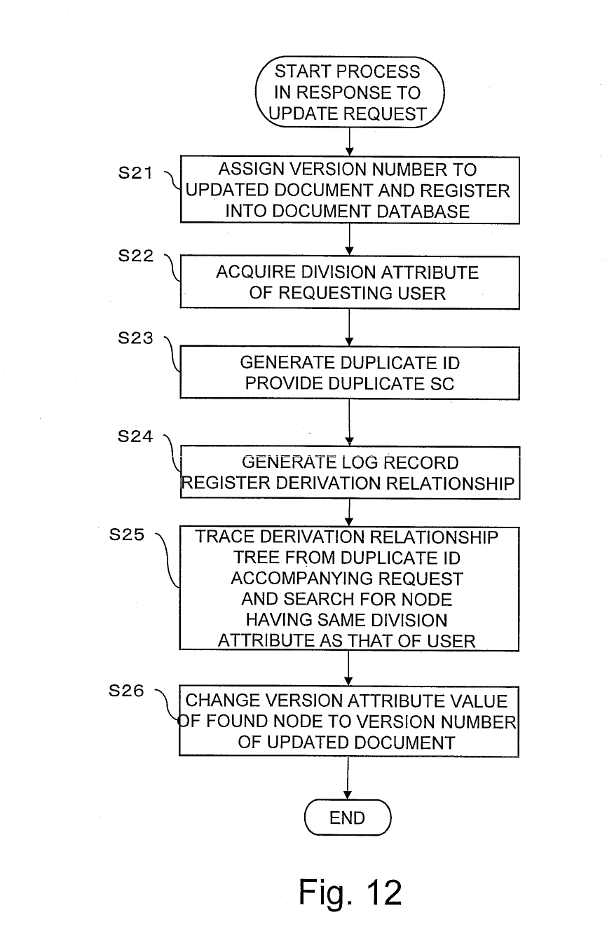

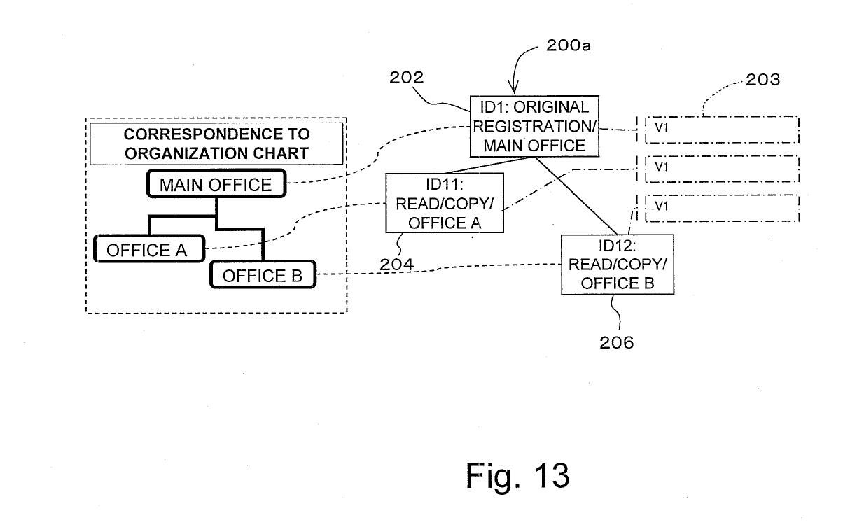

Next, in the overall management method, a procedure of the document registration unit 13a will be described with reference to FIG. 12 when a document update request is received from the user.

The user can edit the content of a document by opening the duplicate file, which was acquired from the read request, on the viewer 22. When the viewer 22, which has a user interface for accepting document update commands, receives a document update command from the user, an update request accompanied with the edited document (referred to as the updated document) is sent to the document management server 10a. The document management server 10a receiving the update request assigns a new version number to the updated document and registers (S21) the updated document into the document database 11a. Furthermore, the document registration unit 13a acquires (S22) the division attribute of the requesting user in the same manner as the aforementioned step S2, generates a unique duplicate ID, and transmits (S23) the duplicate SC including the duplicate ID to the requesting user. Then, a log record is created and derivation relationship information is registered (S24). As described hereinabove, the value of the attribute information of the requesting user causing the event and the version number of the document stored in the document database 11a were registered into the log record for the document registration request. In the log record for the update request, however, the division attribute value and the version number are not registered. Instead, the document registration unit 13a traces the derivation relationship tree starting from the duplicate ID accompanying the update request, searches (S25) for a node having the same division attribute value as that of the user, namely, the base node of the division to which the user belongs, and changes (S26) the value of the version attribute of the base node to the version number that was assigned to the updated document in step S21.

The process flow in this system will be described using a specific example. As shown in FIG. 13, an organizational structure is illustrated having two divisions called “Office A” and “Office B” under a “Main Office”. Then, a case is considered where a document, which is created at the main office, is passed to office A and office B and separately updated at office A and office B. FIG. 13 shows a derivation relationship tree 200a and correspondence to an organization chart showing an organizational structure. To clarify the description, each node 202, 204, 206 of the derivation relationship tree 200a in FIG. 13 is shown with the respective value of a duplicate ID issued at the event corresponding to the node, the event name, and the division attribute information of the destination user for the duplicate ID in a notation method of “duplicate ID: event name/division name”. Furthermore, so as to clarify the hierarchical relationship in this example, the value of the duplicate ID is the duplicate ID of the parent to which has been added to the end a unique value among the children derived from the parent.

The example of FIG. 13 shows an original document that is created by a user 1 belonging to the main office and registered into the document management server 10a. The document management server 10a assigns a version number “V1” 203 to the original and returns a newly created duplicate SC that includes the duplicate ID “ID1” to the user 1. The information relating to the above event is illustrated as node 202. The log record within the log management unit 19 corresponding to the node 202 is the record of the “document registration” event in the second line from the top of the table shown in FIG. 14.

It is assumed user 1 has respectively provided, such as via electronic mail or another transmission medium, the duplicate SC “ID1” to a user 2 belonging to office A and a user 3 belonging to office B. When, for example, user 2 issues a read request to the document management server 10a using the duplicate SC “ID1”, the duplicate provider unit 17a of the document management server 10a executes the process shown in FIG. 11 to find a record (node) where the duplicate ID “ID1” is included in the “provided duplicate ID” and to trace the derivation relationship tree from the node. In this case, this node itself is the root in the derivation relationship tree and includes the version attribute value (V1) so that this node is found in step S11. The duplicate provider unit 17a reads from the document database 11a a document corresponding to version V1 included in the node and provides to user 2 a duplicate file including the document data and a newly generated duplicate ID “ID11”. Since the division of user 2 is “office A” and the division attribute of the node found in step S1 is “main office”, the node corresponding to this read request is the base node of “office A”, which is a subsidiary division of “main office”. Version “V1”, which was acquired in the read operation, and division “office A” are recorded to this node. (Refer to the record of the third line from the top of the table shown in FIG. 14.) Also when user 3 issues a read request using the duplicate SC “ID1”, a duplicate file including a duplicate ID “ID12” and version V1 of the document is similarly provided to user 3 and the node corresponding to the duplicate ID “ID12” is set as the base node of office B. (Refer to the record of the last line in the table of FIG. 14.) The derivation relationship tree 200a illustrated in FIG. 13 shows the state at this time.

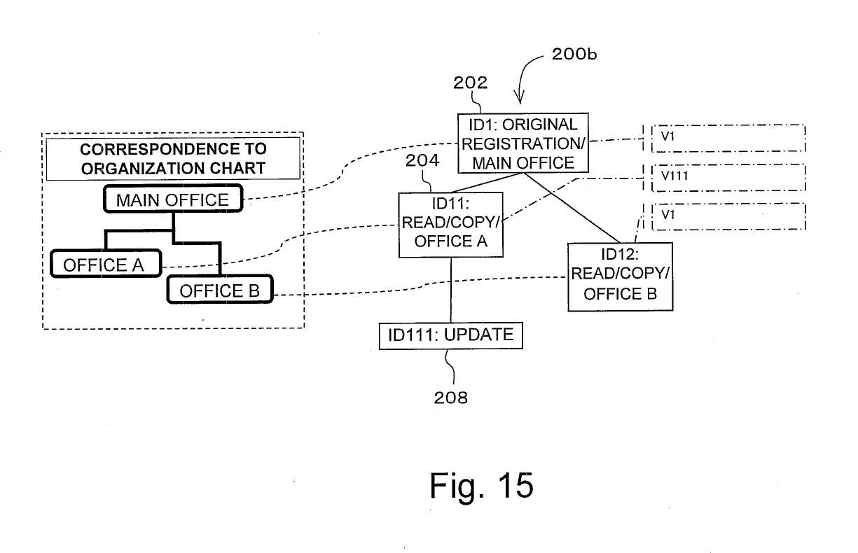

Here, user 2 in office A uses a client program, such as a viewer or a document editor, to edit the document data within the duplicate file acquired in response to the read request and sends an update request accompanied with the edited document data result to the document management server 10a. In this case, as shown in FIG. 15, the document management server 10a assigns a new version number “V111” (in this example, the version number corresponds with the duplicate ID) to the document data accompanying the update request. The document data is then registered into the document database 11a and a duplicate SC including a new duplicate ID “ID111” is returned in response to the update request. Then, a node 208 of the duplicate ID “ID111” is added to the derivation relationship tree and the version attribute value of the base node 204 of office A is updated to version “V111” of the updated document. A derivation relationship tree 200b shown in FIG. 15 shows the derivation relationship at this time. (The part after “/” has been omitted for nodes not having a division attribute value.)

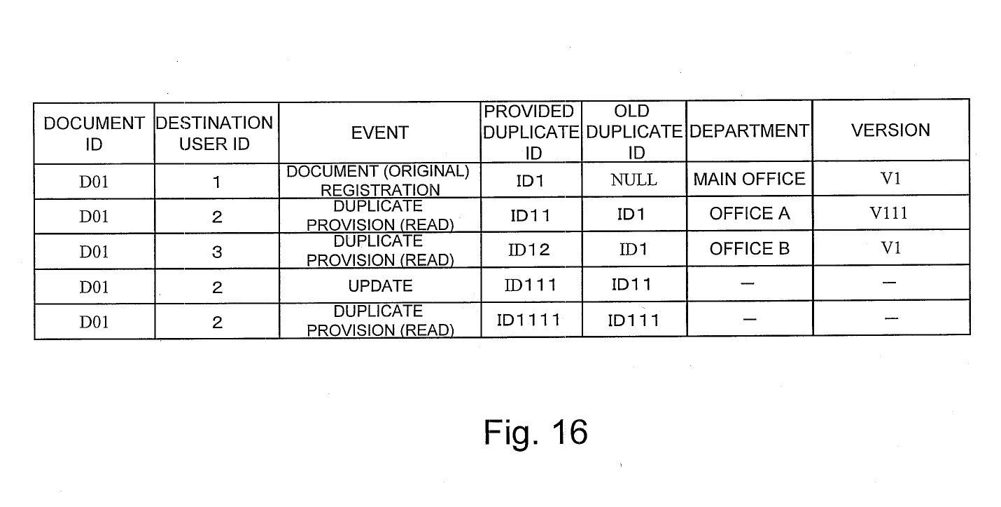

Next, when the same user 2 issues a read request using the duplicate SC “ID111”, the document management server 10a traces the derivation relationship tree 200b from “ID111” to the root and finds node 204 as the first node that has been set a the version attribute value. Then, the document database 11a is searched for document data corresponding to the version attribute value “V111” of the node 204 in the version group for document ID “D01” and a duplicate file including a newly generated duplicate ID “ID1111” and its document data is provided to user 2. The log data of the log management unit 19 at this time is shown in FIG. 16. At the client terminal 20 of user 2 receiving the duplicate file, the duplicate ID of the duplicate SC corresponding to the document “D01” has been updated to “ID1111”.

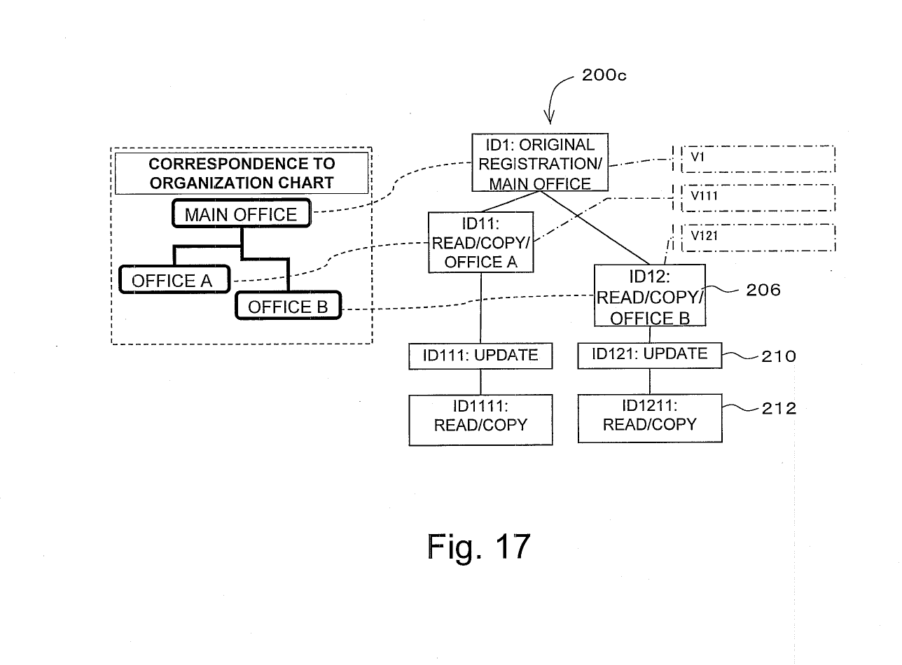

Thereafter, user 3 in office B updates the duplicate file “ID12” acquired in response to the read request and registers the updated result into the document management server 10a and further reads the updated result. In this case, the derivation relationship tree is shown as a tree 200c in FIG. 17. At the base node 206 of office B in the derivation relationship tree is registered a new version number V12 that was registered by an update event 210 by user 3. At a read event 212 by the next user 3, document data of version V12 is provided.

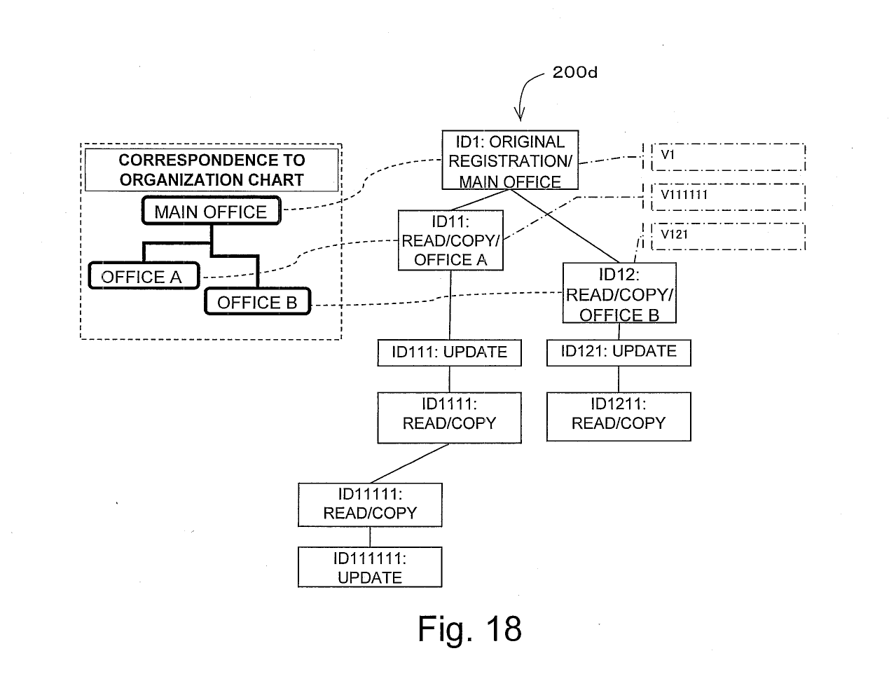

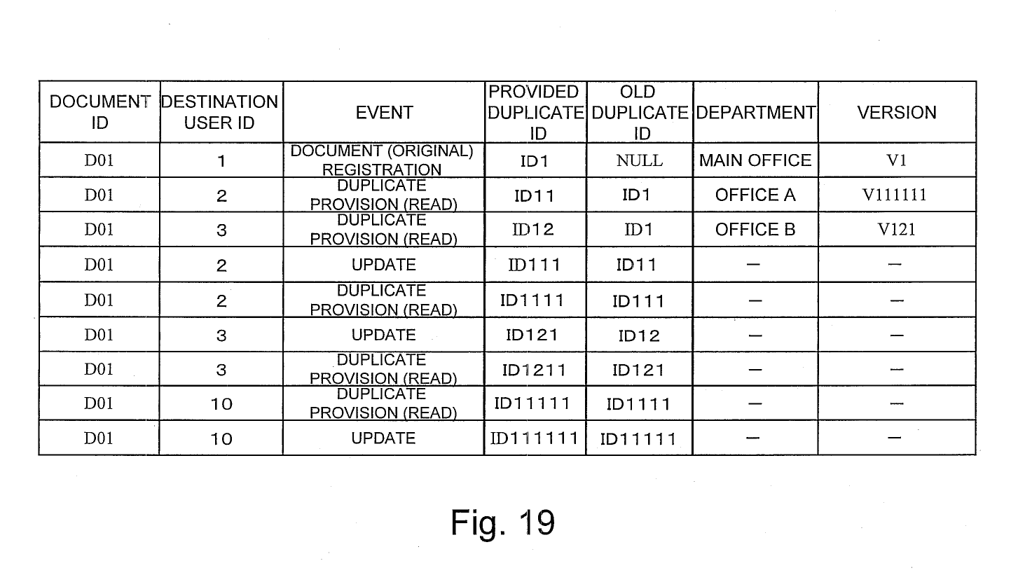

Thereafter, user 2 sends, such as via electronic mail, the duplicate SC “ID1111” to a user 10 in the same office A and user 10 reads and updates using the duplicate SC. In this case, in response to the read request, the document management server 10a traces the derivation relationship tree 200c and provides to user 10 a duplicate file including document data of version V111 corresponding to base A node 204 of office A and a new duplicate ID “ID11111”. User 10 edits the duplicate file and issues an update request accompanying the edited result. Then, the document management server 10a assigns a new version number “V111111” to the edited result, registers the result into the document DB 11a, and updates the version attribute value of the base node 204 of office A to version number “V111111”. The derivation relationship tree 200d at this time is shown in FIG. 18 and the corresponding log data is shown in FIG. 19.

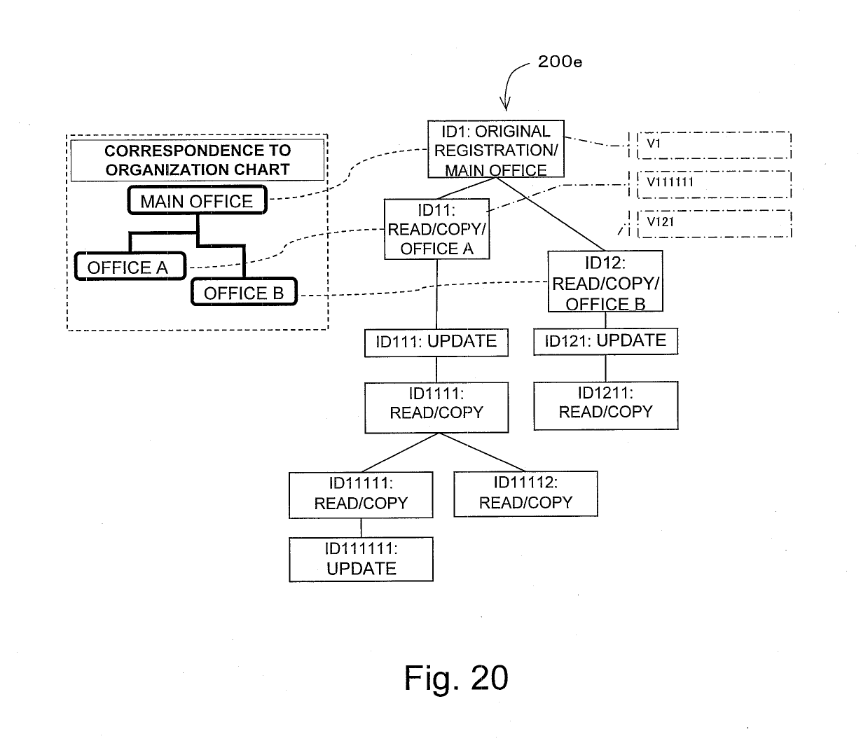

Further thereafter, user 2 again reads the same document “D01” by using the duplicate SC “ID1111”. In this case the document management server 10a traces a derivation relationship tree 200d from “IDllll”, acquires version attribute value “Vllllll” of the base node 204 of office A, and provides to user 2 a duplicate file including a new duplicate ID “ID11112” and the document of that version. As a result, user 2 reads the version after the update by user 10. The derivation relationship tree 200e at this time is shown in FIG. 20.

Hereinabove, when a document registration request is received from a user, the document management server 10a automatically sets the division attribute value with the node corresponding to the request as the base node. Furthermore, when a read request is received from a user, the document management server 10a judges whether the request applies to a base node at a subsidiary division by tracing and checking the derivation relationship tree and sets the division attribute value to the base node. However, this process is not always necessary. Instead, for example, the user issuing the document registration request or read request declares oneself as the base node of the division through the client terminal 20. In response, the client terminal 20 sends division attribute information of the user and information indicating the request event is the base node to the document management server 10a. In response, the document management server 10a may set the division attribute value to the node of the relevant request.

Furthermore, there are instances where a user holds positions in multiple divisions. For example, like the leader of office A being a member of the main office (i.e. management), the leader of a subsidiary division being a member of a higher division is one example. In this case, when a user issues a request to the document management server 10a, it is preferable for the user to specify the division to which the user belongs. For example, when the document management server 10a checks the division attribute of the requesting user from the organization information management server 40 and multiple values exist, an inquiry may be posed to the user asking as a member of which division was the request issued. Furthermore, when the user issues a request, the client terminal 20 acquires the division attribute of the user from the organization information management server 40, and if there are multiple division attributes, can allow the user to select the appropriate division attribute. In this case, the selected division attribute accompanies the request and is sent to the document management server 10a.

Furthermore, the aforementioned example was given for the case where the document update performed in the overall management method. However, the document update is also possible in other methods. For example, a method for recording differential data for the document, before and after the update, can be considered. The differential data may be created by an application, such as the viewer 22 or a document editor, at the client terminal 20 or by the document management server 10a. An example of embodying the former will be described hereinafter.

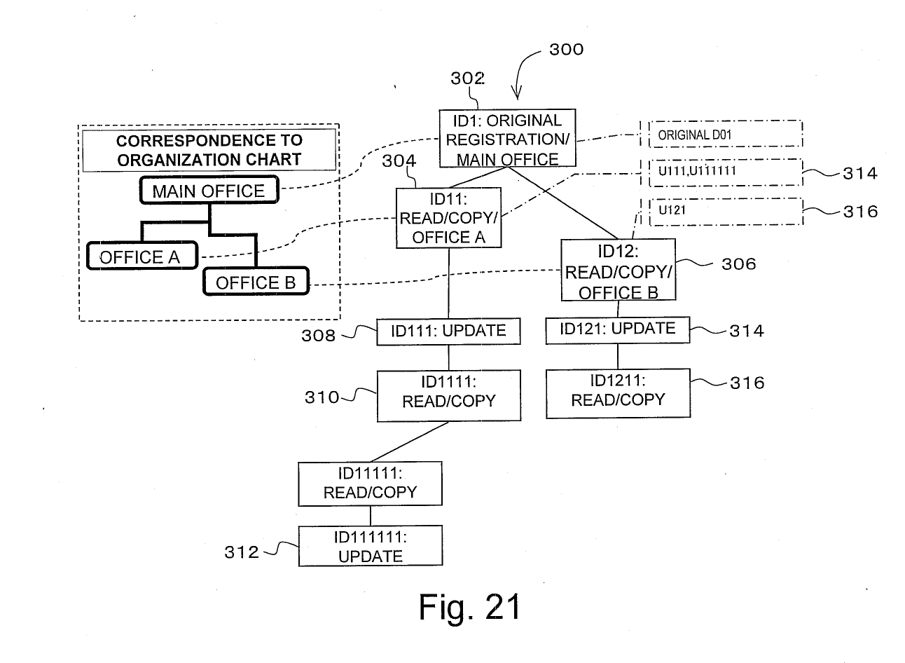

In this embodiment, as shown in FIG. 21, a root node 302 in the derivation relationship tree, namely, the node indicating document registration of the original, has a document ID “D01” 332 of the original (or document data of the original). A derivation relationship tree 300 is shown in FIG. 21 and is an example when the state indicated by the derivation relationship tree 200d in FIG. 18 for the embodiment of the overall management method is expressed in the differential management method. In this example, a base node 304 of division “office A” below the “main office” is recorded with differential data 334 of an update performed by a member of the division using the duplicate ID of a descendent of the base node. The differential data is generated by an application, such as the viewer 22, at the client terminal 20 and sent to the document management server 10a. For example, the differential data “U111” and “U111111” for when updates are performed at descendent nodes 308, 312 of the base node 304 are associated with the base node 304 and stored. The differential data “U111” is the difference between the original “D01” and the updated document result at the node 308 while the differential data “U111111” is the difference between the updated document result at the node 308 and the updated document result at the node 312.

In this case, for example, in response to a read request of a node 310, the document management server 10a traces the derivation relationship tree 300 from the node 308 to the root node 302, finds the base node 304, and provides to the request origin a duplicate file including the differential data “U111” (differential data “U111111” is unregistered at this time) and the original “D01” of the root node 302. In this example, there is only one differential data. However, when there are multiple differential data, the time sequence information of all differential data is also included and provided. The viewer 22 at the client terminal 20 of the request origin applies all differential data according to the time sequence and generates a document reflecting all updates and then provides the document to the user. When the user further edits the provided document and issues an update request command, the viewer 22 sends an update request accompanied with differential data indicating the edited content (i.e. difference between the document first provided to the user by the viewer 22 and the final edited result) to the document management server 10a.

In the example of FIG. 21, a base node 306 of office B is registered with differential data “U12” when a descendent node 314 is updated.

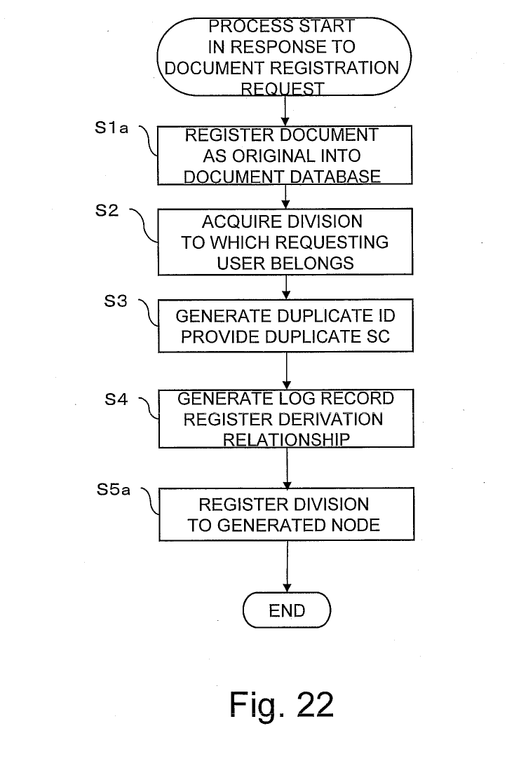

Next, a process of the document management server 10a for implementing this management will be described. First, in the differential management method, a procedure for the document management server 10a will be described with reference to FIG. 22 for a case where a document registration request for original registration is received from a user. In FIG. 22, the steps identical to those in the procedure of FIG. 10 are designated like reference characters and their descriptions will be omitted.

In the procedure of FIG. 22, the document registration unit 13a first registers (S1a) into the document database 11a a document received from the client terminal 20 accompanying a document registration request. Then, a duplicate SC is returned to the client terminal 20, a log record is generated (S3, S4) and a division attribute of the requesting user that was acquired in step S2 is recorded (S5a) into the generated log record (node).

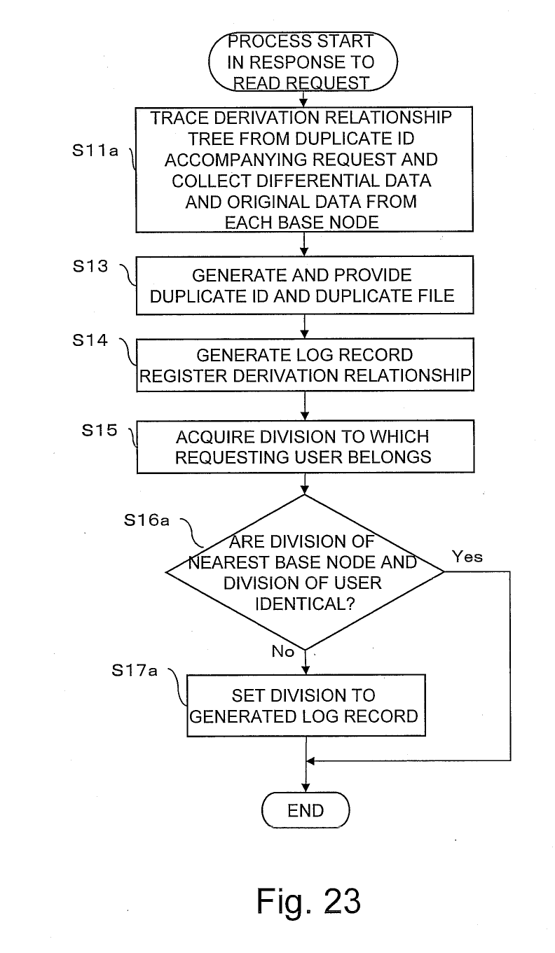

Next, a procedure of the duplicate provider 17a when a document read request is received from a user in the differential management method will be described with reference to FIG. 23. In FIG. 23, the steps identical to those in the procedure of FIG. 11 are designated like reference characters and their descriptions will be omitted.

In this procedure, the duplicate provider unit 17a traces the derivation relationship tree 300 starting from the duplicate ID accompanying the read request to the root and collects (S11a) differential data held by each base node during the trace. During this collection, the time sequence information for all the differential data is also obtained. Then, the original held by the root node 302 is collected (S11a). A duplicate file including the differential data in the time sequence and the original and the duplicate ID is generated and provided to the requesting user (S13). Thereafter, the duplicate provider unit 17a generates (S14) a log record, obtains (S15) the division attribute of the requesting user, and judges (S16a) whether or not the obtained division attribute of the user matches the division attribute of the nearest base node from the starting point when tracing the derivation relationship tree 300. If there is no match, the node corresponding to the read request is the base node of the division to which the user belongs so that the division attribute of the user is set (S17a) into the log record corresponding to that node and the process terminates. If there is a match, the process terminates.

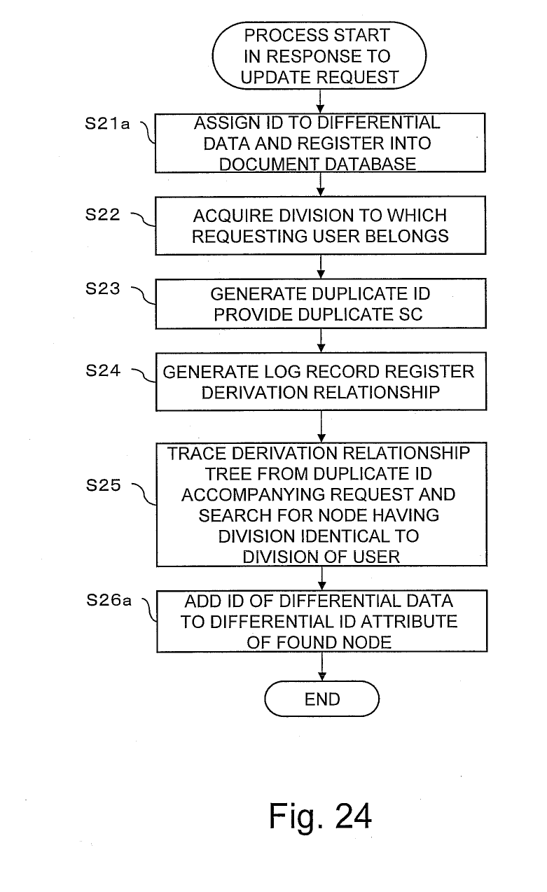

Next, a procedure of the document registration unit 13a will be described with reference to FIG. 24 when a document update request is received from a user in the differential management method. In FIG. 24, the steps identical to those in the procedure of FIG. 12 are designated like reference characters and their descriptions will be omitted.

In this procedure, the document registration unit 13a adds an ID (such as “U111”) to the differential data that is received accompanying the update request so that the ID is associated with the differential data and stores (S21a) the data into a storage device, such as the document database 11a. Then, the steps S22-S24 for acquiring the division attribute of the requesting user, providing a duplicate SC, and recording the log record are performed. The derivation relationship tree is traced and a search (S25) is performed for a node having the same division attribute as the division attribute of the user. To the field of the differential ID attribute of the log record corresponding to the found node is added (S26a) the ID that was assigned in step S21.

In this configuration, the information on the time stamp for the differential data can be obtained from the date and time item in the log record and the time sequence of the various differential data can be determined from the time stamps.

An example of the differential management method was given hereinabove. When a read request was issued in the aforementioned example, the document management server 10a traces the derivation relationship tree 300 to the root and collects the differential data at the nodes appearing during the trace and the original. Instead of this, if, with respect to the base node, the differential data and original, which are held at the ancestor base nodes, are held, it is not necessary to trace to the root and it is sufficient only a trace to the nearest base node from the duplicate ID accompanying the read request. In this case, if it is determined that the request corresponds to the base node in the process for the read request in step S16a (FIG. 23), the original and differential data collected in step S11a may be associated with the log record of the read request in step S17a.

Furthermore, although the differential data before and after the update operation was generated at the client terminal 20 in the aforementioned example, the data may of course be generated at the document management server 10a.

In the example described hereinabove, the content of the updates performed by members of a division are collected at the base node of that division. During a read request, the updated contents at that base node are used to generate a duplicate file. Therefore, a user performing a read request can read a document reflecting the latest updates within the division to which the user belongs. Furthermore, according to the framework of this embodiment, when a duplicate SC is transmitted from higher to lower divisions according to the hierarchical structure of the organization, a document provided to a user belonging to a division only includes updates from the division and updates from a directly higher divisions and does not include updates from other divisions. For example, for the read request of a node 316 in the example of FIG. 21, the original “DO1 and differential data 336 indicating an update at the node 314 are provided to the user while the updated results at the node 304, which is not directly above the node 316, and the descendents of the node 304 are not provided to the user. Therefore, adverse effects, such as the confusion caused from the edited content of another division, can be alleviated.

The aforementioned example illustrated document management for the case where the document body is updated. However, for a document that was first registered and then added with document attachments in a lower division, similar document management is possible also in the method for updating a document set (formed from one or more documents).

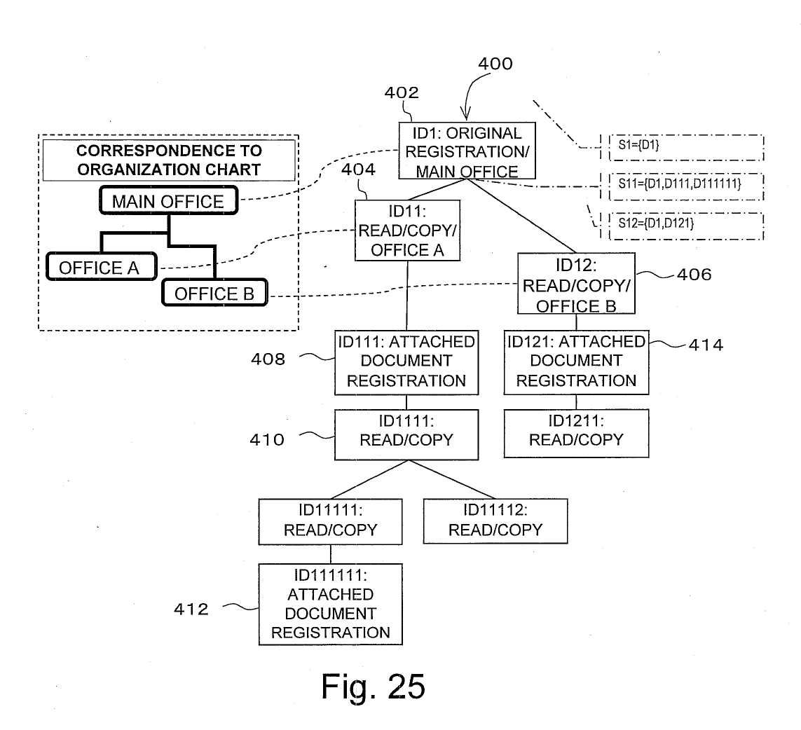

In this method, as shown in FIG. 25, a document set is associated with the base node and shared with division of the base node. For example, in a derivation relationship tree 400 of FIG. 25, the document “D1”, which is an original, is associated to a root node 402, which is the base node of the main office. At this time, when the duplicate SC “ID1” user 1 obtained by user 1 is provided to user 2 of office A and user 2 uses this duplicate SC “ID1” to issue a read request, the document registration unit 13a finds the document set S1 that has been registered in the root node 420, which is the first base node from the duplicate ID “ID1”, and provides a duplicate file including the document set to user 2. This read event is added to the derivation relationship tree 400 as a node 404. Here, the node 404 becomes the base node of office A and the document attachments “D111” and “D111111” that are registered at node 408 and node 412 derived from the node 404 are registered into a document set S11 of the node 404. On the other hand, for the read request of a node 410, the document set S11 of the first base node 404 that is encountered when tracing the derivation relationship tree 400 is provided to the user. Similarly, a node 406 becomes the base node of office B and the document attachment “D121” that is registered at a node 414 is registered into a document set S12 of the node 406 and the document set S11 of the node 406 is provided in response to the read request at a descendent node of the node 406.

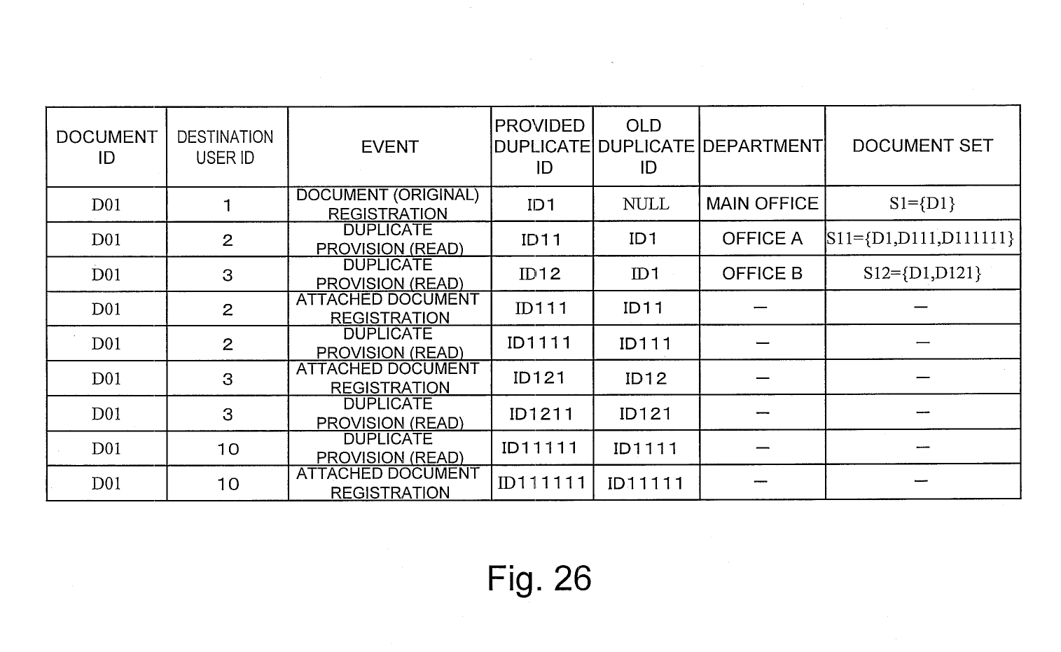

The document set can be registered, for example, as one item in the log record as shown in FIG. 26. FIG. 26 shows the log data corresponding to the same point in time as the derivation relationship tree of FIG. 25.

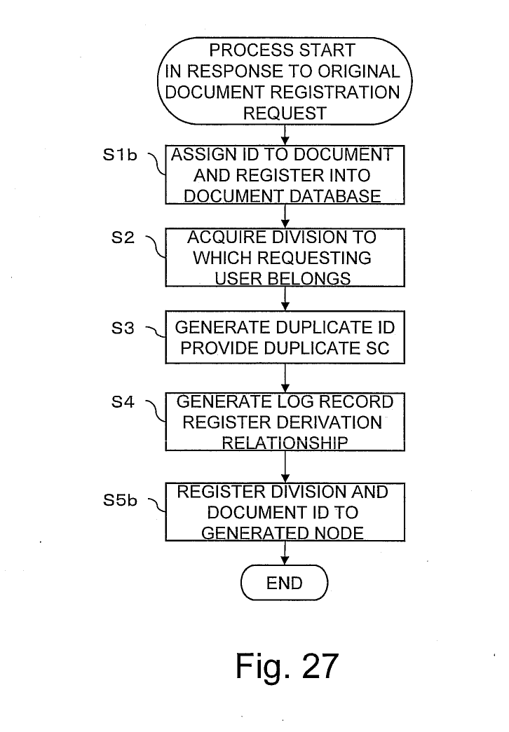

Next, a process of the document management server 10a for implementing this management will be described. First, a procedure of the document registration unit 13a will be described with reference to FIG. 27 when an original document registration request is received from a user. In FIG. 27, the steps identical to those in the procedure of FIG. 10 are designated like reference characters and their descriptions will be omitted.

First, in the procedure of FIG. 27, the document registration unit 13a assigns an ID to a document received from the client terminal 20 accompanying the document registration request and registers the document (S1b) into the document database 11a. Then, a duplicate SC is returned to the client terminal 20, a log record is generated (S3, 4), the division attribute of the requesting user acquired in step S2 is registered as the division attribute of the generated log record (node), and the ID assigned in step Sib is added to the field for the document set attribute in the log record (S5b).

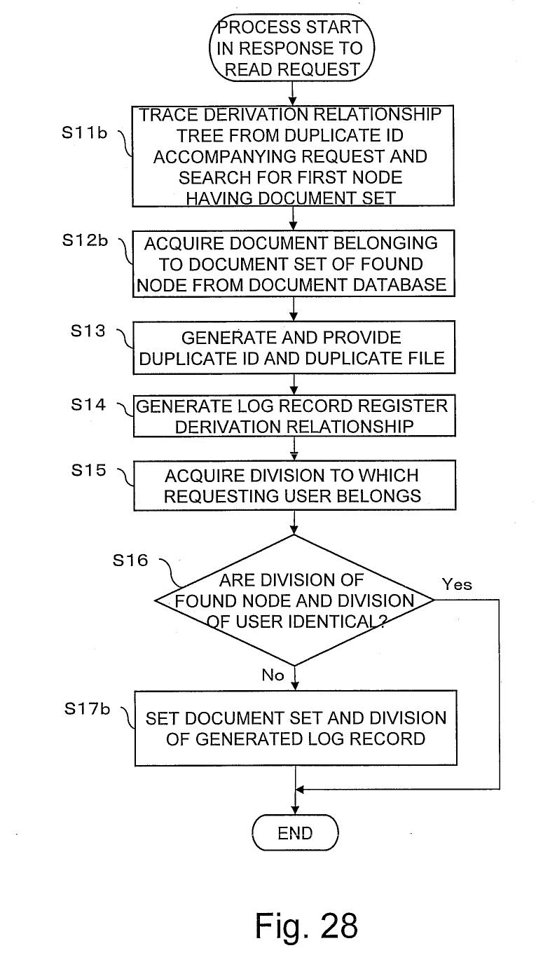

Next, a procedure of the duplicate provider unit 17a will be described with reference to FIG. 28 when a document read request is received from a user. In FIG. 28, the steps identical to those in the procedure of FIG. 11 are designated like reference characters and their descriptions will be omitted.

In this procedure, the duplicate provider unit 17a traces the derivation relationship tree 400 starting from the duplicate ID accompanying the read request and searches (S11b) for a node (namely, base node) having the value of the document set attribute. Then, the documents included in the document set at the first base node that is found in the trace are acquired (S12b) from the document database 11a, a duplicate file including the documents and the duplicate ID is generated and provided (S13) to the original user. Thereafter, the duplicate provider unit 17a generates a log record (S14), obtains the division attribute of the requesting user (S15), and judges (S16) whether or not the division attribute of the requesting user matches the division attribute of the base node obtained in step S11b. If they do not match, the node corresponding to the read request becomes the base node of the division to which the user belongs, the division attribute value of the user is set into the log record corresponding to that node, the document group acquired in step S12b is added (Sl7b) to the document set attribute of the log record, and the process terminates. If they do match, the step S17b is skipped and the process terminates.

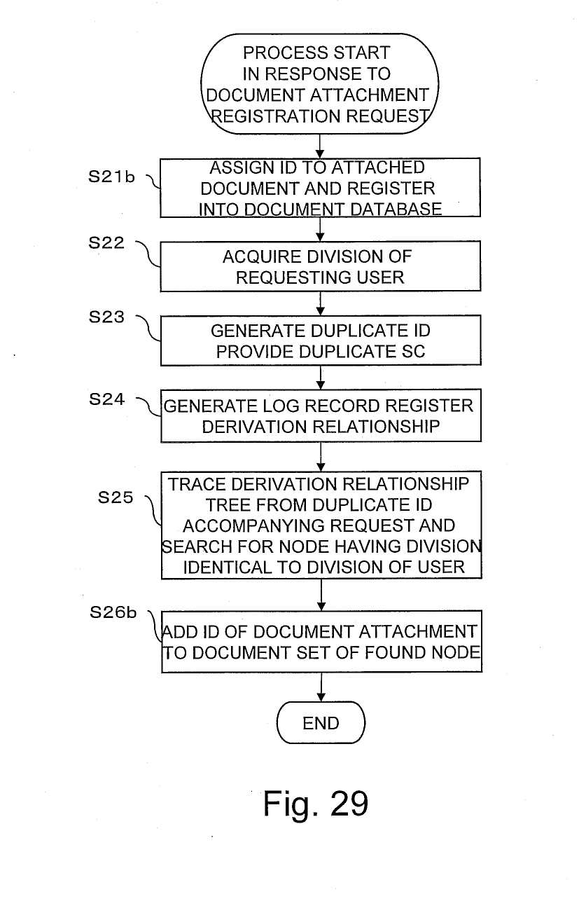

Next, a procedure of the document registration unit 13a will be described with reference to FIG. 29 when a document attachment registration request is received from a user. In FIG. 29, the steps identical to those in the procedure of FIG. 12 are designated like reference characters and their descriptions will be omitted.

In this procedure, the document registration unit 13a an ID (such as “D111”) is added to the document attachment received accompanying the document attachment registration request, the document attachment is associated to the ID and stored (S21b) into the document database 11a. Then, the steps for acquiring the division attribute of the requesting user, providing a duplicate SC, and recording the log record are performed. The derivation relationship tree is traced and a search (S25) is performed for a node having the same division attribute as the division attribute of the user. To the field of the document set attribute of the log record corresponding to the found node is added (S26b) the ID that was assigned in step S21b.

In a document distribution method where document attachments are added to a document set while in distribution as a result of the aforementioned process, the sharing of a document set within a division can be easily achieved. When setting a new base node in the examples of FIG. 25 to FIG. 29, the document set that was registered to a higher base node was passed on and set to the new base node. However, this is not always required. For example, instead of this, as in the example of FIG. 21 in the update information management of the differential management method, only the update information newly generated at the division corresponding to the base node is registered for each base node, the derivation relationship tree is traced to the root upon the read request, and the documents at all base nodes encountered in the trace are collected and provided to the user. In this case, if a document in the document set of a higher node has the same file name as one in the document set of a lower node, the document of the lower node is selected and the document of the higher node having the same file name is ignored. This is applicable to the case where a document being distributed in the document set is updated.

If updates are added by users to documents belonging to a document set, each document in the document set may be managed by the aforementioned methods (overall management method or differential management method) in the embodiments for document updates.

Furthermore, preparing logical components, such as chapters or sections forming a document, into different files (namely, document part files) and expressing one document as a set of the document part files are commonly performed hitherto. Japanese Patent Laid-Open Publication No. 2003-067402 discloses a method for managing update information in the overall management method or differential management method by such individual document part files. In this manner, one document is expressed as a structure formed from multiple document part files and update information is managed for every part file. With the document part file group forming one document treated as the aforementioned document set (where the only difference is whether or not information on the structure forming the document part file group is included) and the aforementioned update and read operations managed individually for the document part files, the management method in this embodiment can be achieved.

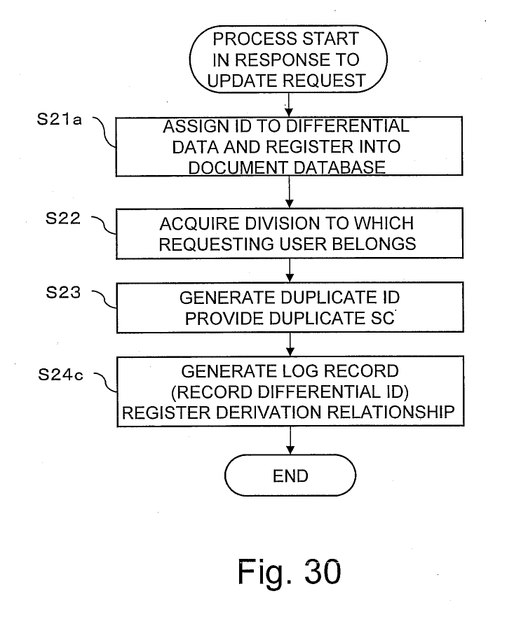

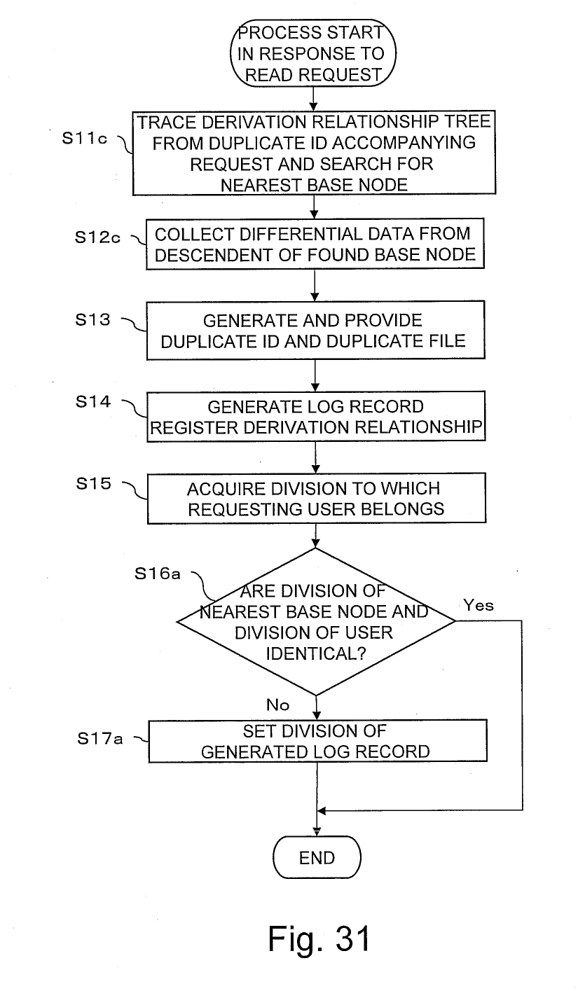

Furthermore, in the aforementioned example, when there is a document update request or a document attachment registration request, the update information or document attachment was registered to the nearest ancestor base node in the derivation relationship tree. However, the collecting of update information or document attachment at the base node need not be performed at the time of the update or registration. They may be performed, for example, when a read request is received. Namely, in this example, at the time of the update request or document attachment registration request, the update information or document attachment is registered into the node corresponding to the request. Then, when there is a read request, an ancestor base node of the node corresponding to the request is found, and the update information or document attachment that has been registered into the descendent nodes of the base node is collected and provided to the requesting user. A procedure of this management applied to an update in the differential management method will be described with reference to FIG. 30 and FIG. 31.

FIG. 30 shows a procedure of the document registration unit 13a when an update request is received. In FIG. 30, the steps identical to those in the procedures of FIG. 12 and FIG. 24 are designated like reference characters and their descriptions will be omitted. In this procedure, the document registration unit 13a first adds an ID to the differential data received accompanying the update request and stores (S21a) the data into a storage device, such as the document database 11a. Then, the division attribute of the requesting user is acquired, a duplicate SC is provided (S22, S23), and a log record is recorded (S24c). The ID assigned to the differential data in step S21a is registered as one attribute into the log recorded that is generated at this time.

FIG. 31 shows a procedure of the duplicate provider unit 17a when a read request is received. In FIG. 31, the steps identical to those in the procedures of FIG. 11 and FIG. 23 are designated like reference characters and their descriptions will be omitted.

In this procedure, the duplicate provider unit 17a traces the derivation relationship tree 300 starting from the duplicate ID accompanying the read request to the root and searches for the first base node that is encountered in the trace (S11c). Then, moving down the derivation relationship tree this time from the found base node toward the descendent, the differential data that has been registered at each node encountered in this downward process is collected (S12c). At this data collection, the day and time attribute of the node to which the differential data belongs is acquired as the time stamp of the differential data and the time sequence of the various differential data is determined from the time stamps. The aforementioned process is performed for all base nodes that are encountered until the root node is reached. The subsequent process may be identical to the process of FIG. 23.

Furthermore, in the aforementioned example, it was assumed that a document was transmitted within the same division or from a higher division to a lower division according to the hierarchical structure of the organization. However, if a case is considered where a document is transmitted to a user in an unrelated division, for example, the following type of control may be performed. Namely, when a read request is received from a user, the document management server 10a determines, in step S16 of the process of FIG. 11, for example, whether or not the division to which the user belongs is below the division indicated by the division attribute of the nearest base node obtained in step S11. If it is not a subsidiary division, a control may be performed to prevent reading. As a result, it is possible to prevent the contents updated within a division to be viewed by a person of an unrelated division.

Furthermore, using the framework of the aforementioned embodiment, the result of an update or addition to a document at a subsidiary division can also be collected for a higher division. This can be accomplished, for example, by a user (such as a leader of a lower division), belonging to a higher division and a lower division, acquiring a document (or document group) resulting from an update or addition at a lower division as a member of a lower division, and issuing a request for an update or addition accompanied with the document (or document group) as a member of a higher division to the document management server 10a. For example, at the point where the derivation relationship tree 400 has the state shown in FIG. 25, when user 2, which is the leader of office A, uses the duplicate SC acquired at the node 410 and issues a read request with the qualification as a member of office A, the duplicate data (or folder) including D1, D111, and D111111 can be acquired. Then, when user 2 (if required, after performing another operation for permission for the duplicate data) issues a document attachment registration request accompanied with the duplicate data, the qualification (membership) of user 2 is switched to a member of the main office. As a result, D1, D111, and D111111 become registered to the root node 402, which is the base node of the main office. In this case, it is preferable to prevent the registration of additions to a document already at the root node 402. For this process, a user interface may be provided at the viewer 22 to let the user select the qualification (the division to which the user belongs).

Furthermore, the derivation relationship tree between duplicate IDs was expressed hereinabove as a correspondence relationship between the “old duplicate ID” and “provided duplicate ID” in the log record group in the log management unit 19. However, the data structure of the derivation relationship tree is not limited to this and may be created separately from the log record group.

The “digital document” in the aforementioned embodiment is not only limited to document data created with a word processor or spreadsheet program but also may include various types of data, such as audio data, image data, video data, multimedia data, and so forth. Therefore, the concept of “reading” a “digital document”-includes the playback of audio data, image data, video data, and multimedia data. Namely, the “reading” of a “digital document” in the aforementioned embodiment includes a generally wide use of digital documents. In other words, in response to an “acquisition request” for a digital document from a user in a system using duplicate SC, the document management server 10 provides a duplicate SC associated to that digital document to the user, and in response to a “usage request” for a digital document using the duplicate SC, a duplicate file that includes a copy of the digital document (or a copy that reflects the differential data or additional data) is provided to the user for “use”.

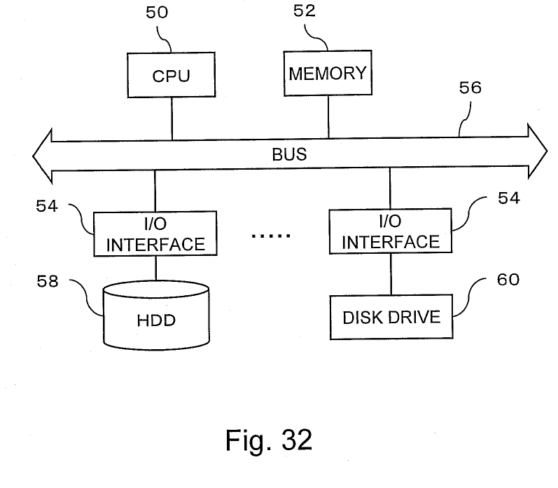

The document management servers 10, 10a forming the system described hereinabove is typically implemented by executing on a general-purpose computer a program that describes the function or processing of each aforementioned part. The computer may have a circuit configuration as shown in FIG. 32 in which a CPU (central processing unit) 50, a memory (primary storage) 52, various I/O interfaces 54, and so forth are connected via a bus 56. Furthermore, a hard disk drive 58 and a disk drive 60 for reading portable non-volatile recording media of various standards, such as CD, DVD, and flash memory, are connected via the I/O interface 54, for example, to the bus 56. The drives 58, 60 function as external storage for memory. The program that describes the processing of the embodiment is stored in a secondary storage device, such as the hard disk drive 58, via a recording medium, such as a CD or DVD, or via a network, and is installed into the computer. The program stored in the secondary storage device is loaded into memory and executed by the CPU to implement the processing of the document management servers 10, 10a in the embodiment. The client terminal 20 in the embodiment can also be implemented similarly by using a general-purpose computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management server for managing digital documents to be provided to clients comprising:
a receiving unit that receives from a client a request and a first ID representing a digital document to be an object of the request;
an ID processing unit that issues, when an operation is performed on the digital document in response to the request, a second ID that is associated to the operation, and records a derivation relationship having the second ID as a child of the first ID;
a base node setting unit that sets a base node to indicate a division of a user among a node group in the derivation relationship;
a document associating unit that associates related data of the digital document registered by an operation corresponding to a descendent node of a base node to the base node; and
a document provider unit that provides, when receiving a user request for a digital document, detects a base node by tracing the derivation relationship from an ID accompanying the request to the root node, and provides the requested document based on related data associated to the detected base node.

2. The document management server according to claim 1, wherein:
the document associating unit, in response to a request for a document update or document addition from a client, associates related data of the received digital document accompanying the request to a base node that is first detected while tracing the derivation relationship from a received ID accompanying the request to the root node.

3. The document management server according to claim 1, wherein:
the related data is a digital document updated according to an update request from a client;
the document associating unit associates the updated digital document to a base node that is first detected while tracing the derivation relationship from a received ID accompanying the update request to the root node;
the document provider unit provides to the client the digital document associated to the base node that is first detected while tracing the derivation relationship from the received ID accompanying the request to the root node.

4. The document management server according to claim 1, wherein:
the related data is differential data after update is executed according to a document update request;
the document provider unit provides to the client associated differential data and information on time sequence of differential data.

5. The document management server according to claim 1, wherein:
the related data is document attachment data corresponding to a document attachment registration request;
the document provider unit provides to the client associated document attachment data.

6. The document management server according to claim 1, wherein:
the base node setting unit sets, when a division indicated by the detected base node and a division to which the client belongs differ, a node of an ID corresponding to the request in the derivation relationship as a base node that indicates the division of the user.

7. The document management server according to claim 6, wherein:
the base node setting unit associates the related data provided by the document provider unit in response to the request to the base node that is set in response to the request.

8. A system for managing document use comprising a document management server that manages digital documents and a client that uses digital documents;
the document management server comprising:
a receiving unit that receives a request from a client and a first ID representing a digital document to be an object of the request;
an ID processing unit that issues, when an operation is performed on the digital document in response to the request, a second ID that is associated to the operation, and records a derivation relationship having the second ID as a child node of the first ID;
a base node setting unit that sets a base node indicating a division of a user in a node group of the derivation relationship;
a document associating unit that associates related data of the digital document registered by an operation corresponding to a descendent node of a base node to the base node; and
a document provider unit that provides, when receiving a user request for a digital document, detects a base node by tracing the derivation relationship from an ID accompanying the request to the root node, and provides the requested document based on related data associated to detected base node;
the client comprising:
an ID management unit that stores an ID received from the document management server in response to a request relating to a digital document as an ID corresponding to the digital document; and
a requesting unit that transmits to the document management server, when the ID stored by the ID management unit is specified and an operation command is received from a user, a request accompanied with the ID.

9. The system for managing document use according to claim 8, wherein:
the client informs the document management server of information indicating one division among a plurality of divisions to which a user issuing the request belongs by associating to the request sent to the document management server by the requesting unit.

10. A computer readable medium storing a program causing a computer to execute a process for document management, the process comprising:
receiving from a client a request and a first ID representing a digital document to be an object of the request;
issuing, when an operation is performed on the digital document in response to the request, a second ID that is associated to the operation;
recording a derivation relationship having the second ID as a child node of the first ID;
setting a base node to indicate a division of a user among a node group in the derivation relationship;
associating related data of the digital document registered by an operation corresponding to a descendent node of a base node to the base node; and
providing to a client, when receiving a user request for a digital document, detects a base node by tracing the derivation relationship from an ID accompanying the request to the root node, and provides the requested document based on related data associated to the detected base node.

11. The medium according to claim 10, wherein:
the associating of the related data comprises, in response to a request from a client for a document update or document addition, associating related data of the received digital document accompanying the request to a base node that is first detected while tracing the derivation relationship from a received ID accompanying the request to the root node.

12. The medium according to claim 10, wherein:
the related data is a digital document updated according to a document update request;
the associating of the related data comprises associating the updated digital document received accompanying the document update request to a base node that is first detected while tracing the derivation relationship from a received ID accompanying the request to the root node;
and providing to the client the digital document associated to the base node that is first detected while tracing the derivation relationship from the received ID accompanying the request to the root node.

13. The medium according to claim 10, wherein:
the related data is differential data after update is executed according to a document update request;
the providing of the document to the client comprises providing to the client associated differential data and information on time sequence of differential data.

14. The medium according to claim 10, wherein:
the related data is document attachment data corresponding to a document attachment registration request;
the providing of the document to the client comprises providing associated document attachment data.

15. The medium according to claim 10, wherein:
the setting of the base node comprises setting, when a division indicated by the detected base node and a division to which the user belongs differ, a node of an ID corresponding to the request in the derivation relationship as a base node that indicates the division of the user.

16. The medium according to claim 15, wherein:
the setting of the base node comprises associating the related data group in response to the request to the base node that is set in response to the request.

17. A method for document management comprising:
receiving from a client a request and a first ID representing a digital document to be an object of the request;
issuing, when an operation is performed on the digital document in response to the request, a second ID that is associated to the operation;
recording a derivation relationship having the second ID as a child node of the first ID;
setting a base node to indicate a division of a user among a node group in the derivation relationship tree;
associating related data of the digital document registered by an operation corresponding to a descendent node of a base node to the base node;
when receiving a user request for a digital document, detecting a base node by tracing the derivation relationship tree from an ID accompanying the request to the root node; and
providing the requested document based on related data associated to detected base node.

18. The method according to claim 17, wherein:
the associating of the related data comprises associating, in response to a request for a document update or document addition, related data of the received digital document accompanying the request to a base node that is first detected while tracing the derivation relationship from a received ID accompanying the request to the root node.

19. A computer data signal implemented on a carrier wave to make it possible to execute a process for document management on a computer, the process comprising:
receiving from a client a request and a first ID representing a digital document to be an object of the request;
issuing, when an operation is performed on the digital document in response to the request, a second ID that is associated to the operation;
recording a derivation relationship having the second ID as a child node of the first ID;
setting a base node to indicate a division of a user among a node group in the derivation relationship;
associating related data of the digital document registered by an operation corresponding to a descendent node of a base node to the base node;
when receiving a user request for a digital document, detecting a base node by tracing the derivation relationship from an ID accompanying the request to the root node; and
providing the requested document based on related data associated to detected base node.

20. The computer data signal according to claim 19, wherein:
the associating of the related data comprises associating, in response to a request for a document update or document addition, related data of the received digital document accompanying the request to a base node that is first detected while tracing the derivation relationship from a received ID accompanying the request to the root node.
